(19) United States
(12) Patent Application Publication
(10) Pub. No.: US 2018/0327661 A1
(43) Pub. Date: Nov. 15, 2018

(54) SILICONE COPOLYMERS AS EMULSIFICATION ADDITIVES FOR QUANTUM DOT RESIN PREMIX

(71) Applicant: NANOSYS, INC., Milpitas, CA (US)

(72) Inventors: David OLMEIJER, San Francisco, CA (US); Anh DUONG, Sunnyvale, CA (US); Austin SMITH, Redwood City, CA (US); Kao SAECHAO, Lodi, CA (US)

(73) Assignee: NANOSYS, INC., Milpitas, CA (US)

(21) Appl. No.: 15/975,811

(22) Filed: May 10, 2018

Related U.S. Application Data
(60) Provisional application No. 62/504,172, filed on May 10, 2017.

(51) Int. Cl. C09K 11/02; C08L 83/08

(52) U.S. Cl. CPC C09K 11/025; C08L 83/08; C08L 2203/20; C08L 2205/03; C08L 2205/08; C08L 2205/025

(57) ABSTRACT

The present invention provides quantum dot compositions and methods of producing quantum dot compositions. The quantum dot compositions comprise a population of quantum dots, a siloxane polymer, an emulsification additive, and an organic resin. The present invention also provides quantum dot films comprising a quantum dot layer and methods of making quantum dot films.

### BACKGROUND OF THE INVENTION

### Field of the Invention

The present invention provides quantum dot compositions and methods of producing quantum dot compositions. The quantum dot compositions comprise a population of quantum dots, a siloxane polymer, an emulsification additive, and an organic resin. The present invention also provides quantum dot films comprising a quantum dot layer and methods of making quantum dot films.

### Background of the Invention

There are several approaches used for quantum dot and/or nanoparticle delivery. Often, when quantum dots are manufactured for commercial purposes they are delivered as a colloidal suspension in an organic solvent such as toluene. However, delivering quantum dots in a solvent to end-users who wish to further process the quantum dots may be problematic for several reasons. First, quantum dots often require the presence of ligands on the quantum dot surfaces for maintaining the optical properties and structural integrity of the quantum dots. However, the ligands present on the quantum dot surfaces can diffuse in a solvent and, as such, the properties of quantum dots may change over time if stored in this way, whether the storage is at a manufacturing facility or an end-user facility. Second, end-users may prefer not to handle the solvents typically used for storage of quantum dots, such as toluene, due to the significant fire and health hazards and the general trend toward reducing volatile organic compounds in industrial settings. Third, the presence of even trace amounts of a carrier solvent may negatively impact the curing properties of a final quantum dot composite, for example, if the final matrix material is a polymer. Fourth, quantum dots stored in solvent may have a short shelf-life since the particles typically have a higher tendency to irreversibly agglomerate and therefore change properties over time. It is to be appreciated that, conventionally, quantum dots are shipped in solution (e.g., as suspended in an organic solvent or water) or as a powder.

Alternatively, quantum dots can also be mixed into a siloxane polymer. U.S. Patent Appl. No. 2015/0203747 describes a method for delivering quantum dots that are dispersed in a polymer bearing the same functional groups as standard light emitting diode (LED) polymer encapsulants, enabling elimination of the use of an organic solvent as a dispersant while ensuring compatibility between the carrier and LED polymers. Also described is a method in which quantum dots are delivered in one part of a two-part silicone formulation, again enabling the elimination of the used of an organic solvent as a dispersant.

The conventional method for producing quantum dot enhancement films entails mixing a quantum dot concentrate—a quantum dot dispersed in a siloxane polymer—with a liquid resin material and then subjecting the mixture to high shear. The result is a heterogeneous solution—the quantum dots reside in domains which are discrete from the bulk of the matrix material.

The amount of shear that is required to break the quantum dot concentrate into smaller and smaller domains is inversely proportional to the viscosity of the resin material. For high viscosity resins, the same amount of mechanical agitation results in much greater shear force than when using a lower viscosity resin. Thus, it is easier to produce small heterogeneous domains of quantum dot concentrate when using higher viscosity resins than when using lower viscosity resins.

The size of the domains in the matrix is determined by two factors: (1) the shear generated during mixing of the quantum dot concentrate and the liquid resin; and (2) the surface tension between the quantum dot concentrate and the liquid resin. With high surface tension, smaller domains (with higher surface area) are very thermodynamically unstable and will tend to aggregate and separate. By actively minimizing the surface tension between the two phases, it is possible to reduce the thermodynamic driving force for domain aggregation.

Domains of smaller size in the matrix are of critical importance for the following reasons: (1) they provide slower coagulation and separation from the mixture; (2) they provide larger surface area of the emulsified droplets; and (3) they provide greater opportunity for refractive index mismatches. The smaller the domains are, the more stable the heterogeneous mixture will be—the rate at which the dispersed domains coagulate and separate will be much lower. And, the larger surface area causes greater opportunity for refractive index mismatches, resulting in increased haze and scattering of light. Increased opportunities for the scattering of light result in increased opportunities for reabsorption of emitted light, resulting in quantum dot enhancement films with warmer white points and increased brightness for the same quantity of quantum dots.

The present invention adds an emulsification additive to the organic resin. Addition of the emulsification additive to the organic resin provides the following advantages: (1) creation of smaller heterogeneous domains; (2) less mechanical agitation during high shear; (3) longer shelf stability; and (4) improved optical properties.

A need exists to prepare quantum dot solutions and/or resin mixes that have improved stability and result in improved optical properties when used to prepare a quantum dot film.

### BRIEF SUMMARY OF THE INVENTION

The present invention provides a quantum dot composition, comprising:

(a) at least one population of quantum dots;

(b) at least one siloxane polymer;

(c) at least one emulsification additive; and

(d) at least one organic resin.

In some embodiments, the quantum dot composition comprises between one and five populations of quantum dots. In some embodiments, the quantum dot composition comprises two populations of quantum dots.

In some embodiments, the at least one population of quantum dots contains a core selected from the group consisting of InP, InZnP, InGaP, CdSe, CdS, CdSSe, CdZnSe, CdZnS, ZnSe, ZnSSe, InAs, InGaAs, and InAsP.

In some embodiments, the quantum dot composition comprises as a weight percentage between 0.0001% and 2% of the at least one population of quantum dots.

In some embodiments, the quantum dot composition comprises between one and five siloxane polymers. In some embodiments, the quantum dot composition comprises two siloxane polymers.

In some embodiments, the quantum dot composition comprises as a weight percentage between 0.01% and 50% of the at least one siloxane polymer.

In some embodiments, the quantum dot composition comprises between one and five emulsification additives. In some embodiments, the quantum dot composition comprises one emulsification additive.

In some embodiments, the at least one emulsification additive is a polymer with an ethylene oxide backbone, an ethylene oxide side chain, or combinations thereof.

In some embodiments, the at least one emulsification additive has the structure of formula II:

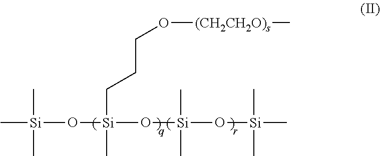

wherein q and r are integers between 1 and 50 and s is an integer between 1 and 20.

In some embodiments, the quantum dot composition comprises as a weight percentage between 0.01% and 50% of the at least one emulsification additive.

In some embodiments, the quantum dot composition comprises between one and five organic resins. In some embodiments, the quantum dot composition comprises two organic resins.

In some embodiments, the at least one organic resin is a thermosetting resin or a UV curable resin. In some embodiments, the at least one organic resin is a UV curable resin.

In some embodiments, the at least one organic resin is a mercaptofunctional compound.

In some embodiments, the quantum dot composition further comprises a thermal initiator or a photoinitiator.

In some embodiments, the quantum dot composition comprises as a weight percentage between 50% and 99% of the at least one organic resin.

In some embodiments, the quantum dot composition is stable for between 1 minute and 3 years.

In some embodiments, the quantum dot composition comprises two populations of quantum dots, two siloxane polymers, one emulsification additives, and two organic resins.

In some embodiments, a molded article is prepared from the quantum dot composition. In some embodiments, the molded article is a film, a substrate for a display, or a light emitting diode. In some embodiments, the molded article is a film.

The present invention also provides a method of preparing a quantum dot composition, comprising:
(a) providing a composition comprising at least one population of quantum dots and at least one siloxane polymer;
(b) admixing at least one emulsification additive with the composition of (a); and
(c) admixing at least one organic resin with the composition of (b).

In some embodiments, a composition comprising two populations of quantum dots is provided in (a).

In some embodiments, the at least one population of quantum dots in (a) contains a core selected from the group consisting of InP, InZnP, InGaP, CdSe, CdS, CdSSe, CdZnSe, CdZnS, ZnSe, ZnSSe, InAs, InGaAs, and InAsP.

In some embodiments, the quantum dot composition comprises as a weight percentage between 0.0001% and 2% of the at least one population of quantum dots.

In some embodiments, a composition comprising between one and five siloxane polymers is provided in (a). In some embodiments, a composition comprising two siloxane polymers is provided in (a).

In some embodiments, the quantum dot composition comprises as a weight percentage between 0.01% and 50% of the at least one siloxane polymer.

In some embodiments, between one and five emulsification additives are admixed in (b). In some embodiments, one emulsification additive is admixed in (b).

In some embodiments, the at least one emulsification additive is a polymer with an ethylene oxide backbone, an ethylene oxide side chain, or combinations thereof.

In some embodiments, the at least one emulsification additive has the structure of formula II:

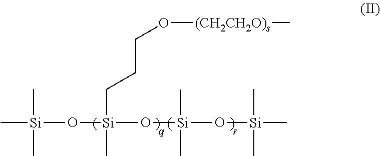

wherein q and r are integers between 1 and 50 and s is an integer between 1 and 20.

In some embodiments, the quantum dot composition comprises as a weight percentage between 0.01% and 50% of the at least one emulsification additive.

In some embodiments, the composition of (a) was stored for between 1 minute and 3 years.

In some embodiments, the admixing in (b) is at an agitation rate between 100 rpm and 10,000 rpm.

In some embodiments, the admixing in (b) is for a time of between 10 minutes and 24 hours.

In some embodiments, two organic resins are admixed in (c).

In some embodiments, the at least one organic resin in (c) is a thermosetting resin or a UV curable resin. In some embodiments, the at least one organic resin in (c) is a UV curable resin.

In some embodiments, the at least one organic resin in (c) is a mercapto-functional compound.

In some embodiments, the method further comprises:
(d) admixing at least one thermal initiator or photoinitiator with the composition of (c).

In some embodiments, the quantum dot composition comprises as a weight percentage between 50% and 99% of the at least one organic resin.

In some embodiments, the admixing in (c) is at an agitation rate between 100 rpm and 10,000 rpm.

In some embodiments, the admixing in (c) is for a time of between 10 minutes and 24 hours.

In some embodiments, the quantum dot composition is stable for between 1 minute and 3 years.

The present invention also provides a method of preparing a quantum dot composition, comprising:
(a) providing a composition comprising at least one population of quantum dots and at least one siloxane polymer;
(b) admixing at least one organic resin with the composition of (a); and
(c) admixing at least one emulsification additive with the composition of (b).

In some embodiments, the composition in (a) comprises two populations of quantum dots.

In some embodiments, the at least one population of quantum dots in (a) contains a core selected from the group consisting of InP, InZnP, InGaP, CdSe, CdS, CdSSe, CdZnSe, CdZnS, ZnSe, ZnSSe, InAs, InGaAs, and InAsP.

In some embodiments, the quantum dot composition comprises as a weight percentage between 0.0001% and 2% of the at least one population of quantum dots.

In some embodiments, the composition in (a) comprises between one and five siloxane polymers. In some embodiments, the composition in (a) comprises two siloxane polymers.

In some embodiments, the quantum dot composition comprises as a weight percentage between 0.01% and 50% of the at least one siloxane polymer.

In some embodiments, two organic resins are admixed in (b).

In some embodiments, the at least one organic resin in (b) is a thermosetting resin or a UV curable resin.

In some embodiments, the at least one organic resin in (b) is a UV curable resin.

In some embodiments, the at least one organic resin in (b) is a mercapto-functional compound.

In some embodiments, the quantum dot composition comprises as a weight percentage between 50% and 99% of the at least one organic resin.

In some embodiments, the admixing in (b) is at an agitation rate between 100 rpm and 10,000 rpm.

In some embodiments, the admixing in (b) is for a time of between 10 minutes and 24 hours.

In some embodiments, the composition of (a) is stored for between 1 minute and 3 years.

In some embodiments, between one and five emulsification additives are admixed in (c). In some embodiments, one emulsification additive is admixed in (c).

In some embodiments, the at least one emulsification additive is a polymer with an ethylene oxide backbone, an ethylene oxide side chain, or combinations thereof.

In some embodiments, the at least one emulsification additive has the structure of formula II:

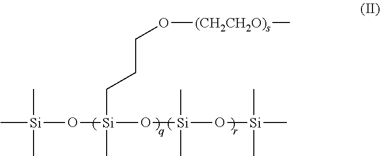

wherein q and r are integers between 1 and 50 and s is an integer between 1 and 20.

In some embodiments, the quantum dot composition comprises as a weight percentage between 0.01% and 50% of the at least one emulsification additive.

In some embodiments, the admixing in (b) is at an agitation rate between 100 rpm and 10,000 rpm.

In some embodiments, the admixing in (b) is for a time of between 10 minutes and 24 hours.

In some embodiments, the method of preparing a quantum dot composition further comprises:
(d) admixing at least one thermal initiator or photoinitiator with the composition of (c).

In some embodiments, the quantum dot composition is stable for between 1 minute and 3 years before further use.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 shows mixture of a quantum dot composition and a low viscosity thiolene UV curable resin containing (a) no emulsification additive; (b) an organic backbone polymer with silicone side chains as an emulsification additive; and (c) a silicone backbone polymer with organic side chains as an emulsification additive.

### DETAILED DESCRIPTION OF THE INVENTION

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and is not intended to be limiting.

As used in this specification and the appended claims, the singular forms “a,” “an” and “the” include plural referents unless the context clearly dictates otherwise. Thus, for example, reference to “a nanostructure” includes a plurality of such nanostructures, and the like.

The term “about” as used herein indicates the value of a given quantity varies by ±10% of the value. For example, “about 100 nm” encompasses a range of sizes from 90 nm to 110 nm, inclusive.

A “nanostructure” is a structure having at least one region or characteristic dimension with a dimension of less than about 500 nm. In some embodiments, the nanostructure has a dimension of less than about 200 nm, less than about 100 nm, less than about 50 nm, less than about 20 nm, or less than about 10 nm. Typically, the region or characteristic dimension will be along the smallest axis of the structure. Examples of such structures include nanowires, nanorods, nanotubes, branched nanostructures, nanotetrapods, tripods, bipods, nanocrystals, nanodots, quantum dots, nanoparticles, and the like. Nanostructures can be, e.g., substantially crystalline, substantially monocrystalline, polycrystalline, amorphous, or a combination thereof. In some embodiments, each of the three dimensions of the nanostructure has a dimension of less than about 500 nm, less than about 200 nm, less than about 100 nm, less than about 50 nm, less than about 20 nm, or less than about 10 nm.

The term “heterostructure” when used with reference to nanostructures refers to nanostructures characterized by at least two different and/or distinguishable material types. Typically, one region of the nanostructure comprises a first material type, while a second region of the nanostructure comprises a second material type. In certain embodiments, the nanostructure comprises a core of a first material and at least one shell of a second (or third etc.) material, where the different material types are distributed radially about the long axis of a nanowire, a long axis of an arm of a branched nanowire, or the center of a nanocrystal, for example. A shell can but need not completely cover the adjacent materials to be considered a shell or for the nanostructure to be considered a heterostructure; for example, a nanocrystal characterized by a core of one material covered with small islands of a second material is a heterostructure. In other embodiments, the different material types are distributed at different locations within the nanostructure; e.g., along the major (long) axis of a nanowire or along a long axis of arm of a branched nanowire. Different regions within a heterostructure can comprise entirely different materials, or the different regions can comprise a base material (e.g., silicon) having different dopants or different concentrations of the same dopant.

As used herein, the “diameter” of a nanostructure refers to the diameter of a cross-section normal to a first axis of the nanostructure, where the first axis has the greatest difference in length with respect to the second and third axes (the second and third axes are the two axes whose lengths most nearly equal each other). The first axis is not necessarily the longest axis of the nanostructure; e.g., for a disk-shaped nanostructure, the cross-section would be a substantially circular cross-section normal to the short longitudinal axis of the disk. Where the cross-section is not circular, the diameter is the average of the major and minor axes of that cross-section. For an elongated or high aspect ratio nanostructure, such as a nanowire, the diameter is measured across a cross-section perpendicular to the longest axis of the nanowire. For a spherical nanostructure, the diameter is measured from one side to the other through the center of the sphere.

The terms “crystalline” or “substantially crystalline,” when used with respect to nanostructures, refer to the fact that the nanostructures typically exhibit long-range ordering across one or more dimensions of the structure. It will be understood by one of skill in the art that the term “long range ordering” will depend on the absolute size of the specific nanostructures, as ordering for a single crystal cannot extend beyond the boundaries of the crystal. In this case, “long-range ordering” will mean substantial order across at least the majority of the dimension of the nanostructure. In some instances, a nanostructure can bear an oxide or other coating, or can be comprised of a core and at least one shell. In such instances it will be appreciated that the oxide, shell(s), or other coating can but need not exhibit such ordering (e.g. it can be amorphous, polycrystalline, or otherwise). In such instances, the phrase “crystalline,” “substantially crystalline,” “substantially monocrystalline,” or “monocrystalline” refers to the central core of the nanostructure (excluding the coating layers or shells). The terms “crystalline” or “substantially crystalline” as used herein are intended to also encompass structures comprising various defects, stacking faults, atomic substitutions, and the like, as long as the structure exhibits substantial long range ordering (e.g., order over at least about 80% of the length of at least one axis of the nanostructure or its core). In addition, it will be appreciated that the interface between a core and the outside of a nanostructure or between a core and an adjacent shell or between a shell and a second adjacent shell may contain non-crystalline regions and may even be amorphous. This does not prevent the nanostructure from being crystalline or substantially crystalline as defined herein.

The term “monocrystalline” when used with respect to a nanostructure indicates that the nanostructure is substantially crystalline and comprises substantially a single crystal. When used with respect to a nanostructure heterostructure comprising a core and one or more shells, “monocrystalline” indicates that the core is substantially crystalline and comprises substantially a single crystal.

A “nanocrystal” is a nanostructure that is substantially monocrystalline. A nanocrystal thus has at least one region or characteristic dimension with a dimension of less than about 500 nm. In some embodiments, the nanocrystal has a dimension of less than about 200 nm, less than about 100 nm, less than about 50 nm, less than about 20 nm, or less than about 10 nm. The term “nanocrystal” is intended to encompass substantially monocrystalline nanostructures comprising various defects, stacking faults, atomic substitutions, and the like, as well as substantially monocrystalline nanostructures without such defects, faults, or substitutions. In the case of nanocrystal heterostructures comprising a core and one or more shells, the core of the nanocrystal is typically substantially monocrystalline, but the shell(s) need not be. In some embodiments, each of the three dimensions of the nanocrystal has a dimension of less than about 500 nm, less than about 200 nm, less than about 100 nm, less than about 50 nm, less than about 20 nm, or less than about 10 nm.

The term “quantum dot” (or “dot”) refers to a nanocrystal that exhibits quantum confinement or exciton confinement. Quantum dots can be substantially homogenous in material properties, or in certain embodiments, can be heterogeneous, e.g., including a core and at least one shell. The optical properties of quantum dots can be influenced by their particle size, chemical composition, and/or surface composition, and can be determined by suitable optical testing available in the art. The ability to tailor the nanocrystal size, e.g., in the range between about 1 nm and about 15 nm, enables photoemission coverage in the entire optical spectrum to offer great versatility in color rendering.

A “ligand” is a molecule capable of interacting (whether weakly or strongly) with one or more faces of a nanostructure, e.g., through covalent, ionic, van der Waals, or other molecular interactions with the surface of the nanostructure.

“Photoluminescence quantum yield” is the ratio of photons emitted to photons absorbed, e.g., by a nanostructure or population of nanostructures. As known in the art, quantum yield is typically determined by a comparative method using well-characterized standard samples with known quantum yield values.

As used herein, the term “shell” refers to material deposited onto the core or onto previously deposited shells of the same or different composition and that result from a single act of deposition of the shell material. The exact shell thickness depends on the material as well as the precursor input and conversion and can be reported in nanometers or monolayers. As used herein, “target shell thickness” refers to the intended shell thickness used for calculation of the required precursor amount. As used herein, “actual shell thickness” refers to the actually deposited amount of shell material after the synthesis and can be measured by methods known in the art. By way of example, actual shell thickness can be measured by comparing particle diameters determined from transmission electron microscopy (TEM) images of nanocrystals before and after a shell synthesis.

As used herein, the term “solubilizing group” refers to a substantially non-polar group that has a low solubility in water and high solubility in organic solvents such as hexane, pentane, toluene, benzene, diethylether, acetone, ethyl acetate, dichloromethane (methylene chloride), chloroform, dimethylformamide, and N-methylpyrrolidinone. In some embodiments, the solubilizing group is a long-chain alkyl, a long-chain heteroalkyl, a long-chain alkenyl, a long-chain alkynyl, a cycloalkyl, or an aryl.

As used herein, the term “stable” refers to a mixture or composition that resists change or decomposition due to internal reaction or due to the action of air, heat, light, pressure, or other natural conditions.

As used herein, the term “full width at half-maximum” (FWHM) is a measure of the size distribution of quantum dots. The emission spectra of quantum dots generally have the shape of a Gaussian curve. The width of the Gaussian curve is defined as the FWHM and gives an idea of the size distribution of the particles. A smaller FWHM corresponds to a narrower quantum dot nanocrystal size distribution. FWHM is also dependent upon the emission wavelength maximum.

As used herein, the term “functional group equivalent weight” (FGEW) is used to determine the ratio of the reactive functional groups in a polymer. The FGEW of a polymer is defined as the ratio of the number average molecular weight (NAMW) to the number of functional groups in the polymer (n). It is the weight of a polymer that contains one formula weight of the functional group. The FGEW can be calculated using end-group analysis by counting the number of reactive functional groups and dividing into the number average molecular weight:

FGEW=NAMW/n

where n=the number of reactive functional groups in the monomer.

“Alkyl” as used herein refers to a straight or branched, saturated, aliphatic radical having the number of carbon atoms indicated. In some embodiments, the alkyl is C₁₋₂ alkyl, C₁₋₃ alkyl, C₁₋₄ alkyl, C₁₋₅ alkyl, C₁₋₆ alkyl, C₁₋₇ alkyl, C₁₋₈ alkyl, C₁₋₉ alkyl, C₁₋₁₀ alkyl, C₁₋₁₂ alkyl, C₁₋₁₄ alkyl, C₁₋₁₆ alkyl, C₁₋₁₈ alkyl, C₁₋₂₀ alkyl, C₈₋₂₀ alkyl, C₁₂₋₂₀ alkyl, C₁₄₋₂₀ alkyl, C₁₆₋₂₀ alkyl, or C₁₈₋₂₀ alkyl. For example, C₁₋₆ alkyl includes, but is not limited to, methyl, ethyl, propyl, isopropyl, butyl, isobutyl, sec-butyl, tert-butyl, pentyl, isopentyl, and hexyl. In some embodiments, the alkyl is octyl, nonyl, decyl, undecyl, dodecyl, tridecyl, tetradecyl, pentadecyl, hexadecyl, heptadecyl, octadecyl, nonadecyl, or icosanyl.

“Alkenyl” as used herein refers to a monovalent group derived from a straight- or branched-chain hydrocarbon moiety having at least one carbon-carbon double bond by the removal of a single hydrogen atom. In some embodiments, the alkenyl group contains 2-20 carbon atoms and is a C₂₋₂₀ alkenyl. In some embodiments, the alkenyl group contains 2-15 carbon atoms and is a C₂₋₁₅ alkenyl. In some embodiments, the alkenyl group contains 2-10 carbon atoms and is a C₂₋₁₀ alkenyl. In some embodiments, the alkenyl group contains 2-8 carbon atoms and is a C₂₋₈ alkenyl. In some embodiments, the alkenyl group contains 2-5 carbons and is a C₂₋₅ alkenyl. Alkenyl groups include, for example, ethenyl, propenyl, butenyl, and 1-methyl-2-buten-1-yl.

“Alkynyl” as used herein refers to a monovalent group derived from a straight- or branched-chain hydrocarbon having at least one carbon-carbon triple bond by the removal of a single hydrogen atom. In some embodiments, the alkynyl group contains 2-20 carbon atoms and is a C₂₋₂₀ alkynyl. In some embodiments, the alkynyl group contains 2-15 carbon atoms and is a C₂₋₁₅ alkynyl. In some embodiments, the alkynyl group contains 2-10 carbon atoms and is a C₂₋₁₀ alkynyl. In some embodiments, the alkynyl group contains 2-8 carbon atoms and is a C₂₋₈ alkynyl. In some embodiments, the alkynyl group contains 2-5 carbons and is a C₂₋₅ alkynyl. Representative alkynyl groups include, but are not limited to, ethynyl, 2-propynyl (propargyl), and 1-propynyl.

“Alkylamino” as used herein, refers to a “substituted amino” of the formula (—NR^{K}₂), wherein R^{K} is, independently, a hydrogen or an optionally substituted alkyl group, as defined herein, and the nitrogen moiety is directly attached to the parent molecule.

“Heteroalkyl” as used herein, refers to an alkyl moiety which is optionally substituted with one or more functional groups, and that contain one or more oxygen, sulfur, nitrogen, phosphorus, or silicon atoms, e.g., in place of carbon atoms.

“Cycloalkyl” as used herein, refers to a monovalent or divalent group of 3 to 8 carbon atoms, preferably 3 to 5 carbon atoms derived from a saturated cyclic hydrocarbon. Cycloalkyl groups can be monocyclic or polycyclic. Cycloalkyl can be substituted by C₁₋₃ alkyl groups or halogens.

“Carboxyalkyl” as used herein, refers to a carboxylic acid group (—COOH) appended to a lower alkyl radical.

“Heterocycloalkyl” as used herein, refers to cycloalkyl substituents that have from 1 to 5, and more typically from 1 to 4 heteroatoms in the ring structure. Suitable heteroatoms employed in compounds of the present invention are nitrogen, oxygen, and sulfur. Representative heterocycloalkyl moieties include, for example, morpholino, piperazinyl, piperidinyl, and the like.

The term “alkylene,” as used herein, alone or in combination, refers to a saturated aliphatic group derived from a straight or branched chain saturated hydrocarbon attached at two or more positions, such as methylene (—CH₂—). Unless otherwise specified, the term “alkyl” may include “alkylene” groups.

“Aryl” as used herein refers to unsubstituted monocyclic or bicyclic aromatic ring systems having from six to fourteen carbon atoms, i.e., a C₆₋₁₄ aryl. Non-limiting exemplary aryl groups include phenyl, naphthyl, phenanthryl, anthracyl, indenyl, azulenyl, biphenyl, biphenylenyl, and fluorenyl groups. In one embodiment, the aryl group is a phenyl or naphthyl.

“Heteroaryl” or “heteroaromatic” as used herein refers to unsubstituted monocyclic and bicyclic aromatic ring systems having 5 to 14 ring atoms, i.e., a 5- to 14-membered heteroaryl, wherein at least one carbon atom of one of the rings is replaced with a heteroatom independently selected from the group consisting of oxygen, nitrogen, and sulfur. In one embodiment, the heteroaryl contains 1, 2, 3, or 4 heteroatoms independently selected from the group consisting of oxygen, nitrogen, and sulfur. In one embodiment, the heteroaryl has three heteroatoms. In another embodiment, the heteroaryl has two heteroatoms. In another embodiment, the heteroaryl has one heteroatom. In another embodiment, the heteroaryl is a 5- to 10-membered heteroaryl. In another embodiment, the heteroaryl is a 5- or 6-membered heteroaryl. In another embodiment, the heteroaryl has 5 ring atoms, e.g., thienyl, a 5-membered heteroaryl having four carbon atoms and one sulfur atom. In another embodiment, the heteroaryl has 6 ring atoms, e.g., pyridyl, a 6-membered heteroaryl having five carbon atoms and one nitrogen atom. Non-limiting exemplary heteroaryl groups include thienyl, benzo[b]thienyl, naphtho[2,3-b]thienyl, thianthrenyl, furyl, benzofuryl, pyranyl, isobenzofuranyl, benzooxazonyl, chromenyl, xanthenyl, 2H-pyrrolyl, pyrrolyl, imidazolyl, pyrazolyl, pyridyl, pyrazinyl, pyrimidinyl, pyridazinyl, isoindolyl, 3H-indolyl, indolyl, indazolyl, purinyl, isoquinolyl, quinolyl, phthalazinyl, naphthyridinyl, cinnolinyl, quinazolinyl, pteridinyl, 4aH-carbazolyl, carbazolyl, β-carbolinyl, phenanthridinyl, acridinyl, pyrimidinyl, phenanthrolinyl, phenazinyl, thiazolyl, isothiazolyl, phenothiazolyl, isoxazolyl, furazanyl, and phenoxazinyl. In one embodiment, the heteroaryl is thienyl (e.g., thien-2-yl and thien-3-yl), furyl (e.g., 2-furyl and 3-furyl), pyrrolyl (e.g., 1H-pyrrol-2-yl and 1H-pyrrol-3-yl), imidazolyl (e.g., 2H-imidazol-2-yl and 2H-imidazol-4-yl), pyrazolyl (e.g., 1H-pyrazol-3-yl, 1H-pyrazol-4-yl, and 1H-pyrazol-5-yl), pyridyl (e.g., pyridin-2-yl, pyridin-3-yl, and pyridin-4-yl), pyrimidinyl (e.g., pyrimidin-2-yl, pyrimidin-4-yl, and pyrimidin-5-yl), thiazolyl (e.g., thiazol-2-yl, thiazol-4-yl, and thiazol-5-yl), isothiazolyl (e.g., isothiazol-3-yl, isothiazol-4-yl, and isothiazol-5-yl), oxazolyl (e.g., oxazol-2-yl, oxazol-4-yl, and oxazol-5-yl), isoxazolyl (e.g., isoxazol-3-yl, isoxazol-4-yl, and isoxazol-5-yl), or indazolyl (e.g., 1H-indazol-3-yl). The term “heteroaryl” also includes possible N-oxides. A non-limiting exemplary N-oxide is pyridyl N-oxide.

Unless clearly indicated otherwise, ranges listed herein are inclusive.

A variety of additional terms are defined or otherwise characterized herein.

### Quantum Dot Composition

In some embodiments, the present invention provides a quantum dot composition comprising:

(a) at least one population of quantum dots;

(b) at least one siloxane polymer;

(c) at least one organic resin; and

(d) at least one emulsification additive.

In some embodiments, the quantum dot composition further comprises a solvent.

### Quantum Dot Film Layer

In some embodiments, the present invention provides a quantum dot film layer comprising:

(a) at least one population of quantum dots;

(b) at least one siloxane polymer;

(c) at least one emulsification additive; and

(d) at least one organic resin.

### Quantum Dot Molded Article

In some embodiments, the present invention provides a quantum dot molded article comprising:

(a) at least one population of quantum dots;

(b) at least one siloxane polymer;

(c) at least one emulsification additive; and

(d) at least one organic resin.

In some embodiments, the molded article is a film, a substrate for a display, or a light emitting diode.

In some embodiments, the present invention provides a quantum dot film comprising:

(a) a first barrier layer;

(b) a second barrier layer; and

(c) a quantum dot layer between the first barrier layer and the second barrier layer, wherein the quantum dot layer comprises at least one population of quantum dots; at least one siloxane polymer; at least one emulsification additive; and at least one organic resin.

### Quantum Dots

The quantum dots (or other nanostructures) for use in the present invention can be produced from any suitable material, suitably an inorganic material, and more suitably an inorganic conductive or semiconductive material. Suitable semiconductor materials include any type of semiconductor, including Group II-VI, Group III-V, Group IV-VI, and Group IV semiconductors. Suitable semiconductor materials include, but are not limited to, Si, Ge, Sn, Se, Te, B, C (including diamond), P, BN, BP, BAs, AlN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, and combinations thereof.

The synthesis of Group II-VI nanostructures has been described in U.S. Pat. Nos. 6,225,198, 6,322,901, 6,207,229, 6,607,829, 6,861,155, 7,060,243, 7,125,605, 7,374,824, 7,566,476, 8,101,234, and 8,158,193 and in U.S. Patent Appl. Publication Nos. 2011/0262752 and 2011/0263062. In some embodiments, the core is a Group II-VI nanocrystal selected from the group consisting of ZnO, ZnSe, ZnS, ZnTe, CdO, CdSe, CdS, CdTe, HgO, HgSe, HgS, and HgTe. In some embodiments, the core is a nanocrystal selected from the group consisting of ZnSe, ZnS, CdSe, and CdS.

Although Group II-VI nanostructures such as CdSe and CdS quantum dots can exhibit desirable luminescence behavior, issues such as the toxicity of cadmium limit the applications for which such nanostructures can be used. Less toxic alternatives with favorable luminescence properties are thus highly desirable. Group III-V nanostructures in general and InP-based nanostructures in particular, offer the best known substitute for cadmium-based materials due to their compatible emission range.

In some embodiments, the nanostructures are free from cadmium. As used herein, the term “free of cadmium” is intended that the nanostructures contain less than 100 ppm by weight of cadmium. The Restriction of Hazardous Substances (RoHS) compliance definition requires that there must be no more than 0.01% (100 ppm) by weight of cadmium in the raw homogeneous precursor materials. The cadmium level in the Cd-free nanostructures of the present invention is limited by the trace metal concentration in the precursor materials. The trace metal (including cadmium) concentration in the precursor materials for the Cd-free nanostructures, can be measured by inductively coupled plasma mass spectroscopy (ICP-MS) analysis, and are on the parts per billion (ppb) level. In some embodiments, nanostructures that are “free of cadmium” contain less than about 50 ppm, less than about 20 ppm, less than about 10 ppm, or less than about 1 ppm of cadmium.

In some embodiments, the core is a Group III-V nanostructure. In some embodiments, the core is a Group III-V nanocrystal selected from the group consisting of BN, BP, BAs, BSb, AlN, AlP, AlAs, AlSb, GaN, GaP, GaAs, GaSb, InN, InP, InAs, and InSb. In some embodiments, the core is a InP nanocrystal.

The synthesis of Group III-V nanostructures has been described in U.S. Pat. Nos. 5,505,928, 6,306,736, 6,576,291, 6,788,453, 6,821,337, 7,138,098, 7,557,028, 7,645,397, 8,062,967, and 8,282,412 and in U.S. Patent Appl. Publication No. 2015/236195. Synthesis of Group III-V nanostructures has also been described in Wells, R. L., et al., “The use of tris(trimethylsilyl)arsine to prepare gallium arsenide and indium arsenide,” Chem. Mater. 1:4-6 (1989) and in Guzelian, A. A., et al., “Colloidal chemical synthesis and characterization of InAs nanocrystal quantum dots,” Appl. Phys. Lett. 69: 1432-1434 (1996).

Synthesis of InP-based nanostructures has been described, e.g., in Xie, R., et al., “Colloidal InP nanocrystals as efficient emitters covering blue to near-infrared,” J. Am. Chem. Soc. 129:15432-15433 (2007); Micic, O. I., et al., “Core-shell quantum dots of lattice-matched ZnCdSe₂ shells on InP cores: Experiment and theory,” J. Phys. Chem. B 104:12149-12156 (2000); Liu, Z., et al., “Coreduction colloidal synthesis of III-V nanocrystals: The case of InP,” Angew. Chem. Int. Ed. Engl. 47:3540-3542 (2008); Li, L. et al., “Economic synthesis of high quality InP nanocrystals using calcium phosphide as the phosphorus precursor,” Chem. Mater. 20:2621-2623 (2008); D. Battaglia and X. Peng, “Formation of high quality InP and InAs nanocrystals in a noncoordinating solvent,” Nano Letters 2:1027-1030 (2002); Kim, S., et al., “Highly luminescent InP/GaP/ZnS nanocrystals and their application to white light-emitting diodes,” J. Am. Chem. Soc. 134:3804-3809 (2012); Nann, T., et al., “Water splitting by visible light: A nanophotocathode for hydrogen production,” Angew. Chem. Int. Ed. 49:1574-1577 (2010); Borchert, H., et al., “Investigation of ZnS passivated InP nanocrystals by XPS,” Nano Letters 2:151-154 (2002); L. Li and P. Reiss, “One-pot synthesis of highly luminescent InP/ZnS nanocrystals without precursor injection,” J. Am. Chem. Soc. 130:11588-11589 (2008); Hussain, S., et al. “One-pot fabrication of high-quality InP/ZnS (core/shell) quantum dots and their application to cellular imaging,” Chemphyschem. 10:1466-1470 (2009); Xu, S., et al., “Rapid synthesis of high-quality InP nanocrystals,” J. Am. Chem. Soc. 128:1054-1055 (2006); Micic, O. I., et al., “Size-dependent spectroscopy of InP quantum dots,” J. Phys. Chem. B 101:4904-4912 (1997); Haubold, S., et al., “Strongly luminescent InP/ZnS core-shell nanoparticles,” Chemphyschem. 5:331-334 (2001); CrosGagneux, A., et al., “Surface chemistry of InP quantum dots: A comprehensive study,” J. Am. Chem. Soc. 132:18147-18157 (2010); Micic, O. I., et al., “Synthesis and characterization of InP, GaP, and GaInP₂ quantum dots,” J. Phys. Chem. 99:7754-7759 (1995); Guzelian, A. A., et al., “Synthesis of size-selected, surface-passivated InP nanocrystals,” J. Phys. Chem. 100:7212-7219 (1996); Lucey, D. W., et al., “Monodispersed InP quantum dots prepared by colloidal chemistry in a non-coordinating solvent,” Chem. Mater. 17:3754-3762 (2005); Lim, J., et al., “InP@ZnSeS, core@composition gradient shell quantum dots with enhanced stability,” Chem. Mater. 23:4459-4463 (2011); and Zan, F., et al., “Experimental studies on blinking behavior of single InP/ZnS quantum dots: Effects of synthetic conditions and UV irradiation,” J. Phys. Chem. C 116:394-3950 (2012).

In some embodiments, the core is doped. In some embodiments, the dopant of the nanocrystal core comprises a metal, including one or more transition metals. In some embodiments, the dopant is a transition metal selected from the group consisting of Ti, Zr, Hf, V, Nb, Ta, Cr, Mo, W, Mn, Tc, Re, Fe, Ru, Os, Co, Rh, Ir, Ni, Pd, Pt, Cu, Ag, Au, and combinations thereof. In some embodiments, the dopant comprises a non-metal. In some embodiments, the dopant is ZnS, ZnSe, ZnTe, CdSe, CdS, CdTe, HgS, HgSe, HgTe, CuInS₂, CuInSe₂, AlN, AlP, AlAs, GaN, GaP, or GaAs.

Inorganic shell coatings on quantum dots are a universal approach to tailoring their electronic structure. Additionally, deposition of an inorganic shell can produce more robust particles by passivation of surface defects. Ziegler, J., et al., Adv. Mater. 20:4068-4073 (2008). For example, shells of wider band gap semiconductor materials such as ZnS can be deposited on a core with a narrower band gap—such as CdSe or InP—to afford structures in which excitons are confined within the core. This approach increases the probability of radiative recombination and makes it possible to synthesize very efficient quantum dots with quantum yields close to unity and thin shell coatings.

In certain embodiments, the nanostructure comprises a core of a first material and at least one shell of a second (or third etc.) material, where the different material types are distributed radially about the long axis of a nanowire, a long axis of an arm of a branched nanowire, or the center of a nanocrystal, for example. A shell can but need not completely cover the adjacent materials to be considered a shell or for the nanostructure to be considered a heterostructure; for example, a nanocrystal characterized by a core of one material covered with small islands of a second material is a heterostructure. In other embodiments, the different material types are distributed at different locations within the nanostructure; e.g., along the major (long) axis of a nanowire or along a long axis of arm of a branched nanowire. Different regions within a heterostructure can comprise entirely different materials, or the different regions can comprise a base material (e.g., silicon) having different dopants or different concentrations of the same dopant.

In some embodiments, the nanostructures of the present invention include a core and at least one shell. In some embodiments, the nanostructures of the present invention include a core and at least two shells. The shell can, e.g., increase the quantum yield and/or stability of the nanostructures. In some embodiments, the core and the shell comprise different materials. In some embodiments, the nanostructure comprises shells of different shell material.

Exemplary materials for preparing shells include, but are not limited to, Si, Ge, Sn, Se, Te, B, C (including diamond), P, Co, Au, BN, BP, BAs, AlN, AlP, AlAs, AlSb, GaN, GaP, GaAs, GaSb, InN, InP, InAs, InSb, GaSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO₃ and combinations thereof.

In some embodiments, the shell is a mixture of at least two of a zinc source, a selenium source, a sulfur source, a tellurium source, and a cadmium source. In some embodiments, the shell is a mixture of two of a zinc source, a selenium source, a sulfur source, a tellurium source, and a cadmium source. In some embodiments, the shell is a mixture of three of a zinc source, a selenium source, a sulfur source, a tellurium source, and a cadmium source. In some embodiments, the shell is a mixture of: zinc and sulfur; zinc and selenium; zinc, sulfur, and selenium; zinc and tellurium; zinc, tellurium, and sulfur; zinc, tellurium, and selenium; zinc, cadmium, and sulfur; zinc, cadmium, and selenium; cadmium and sulfur; cadmium and selenium; cadmium, selenium, and sulfur; cadmium and zinc; cadmium, zinc, and sulfur; cadmium, zinc, and selenium; or cadmium, zinc, sulfur, and selenium.

Exemplary core/shell luminescent nanocrystals for use in the practice of the present invention include, but are not limited to (represented as core/shell) CdSe/ZnS, InP/ZnS, PbSe/PbS, CdSe/CdS, CdTe/CdS, and CdTe/ZnS. The synthesis of core/shell nanostructures is disclosed in U.S. Pat. No. 9,169,435.

The luminescent nanocrystals can be made from a material impervious to oxygen, thereby simplifying oxygen barrier requirements and photostabilization of the quantum dots in the quantum dot film layer. In exemplary embodiments, the luminescent nanocrystals are coated with one or more organic polymeric ligand material and dispersed in an organic polymeric matrix comprising one or more matrix materials, as discussed in more detail below. The luminescent nanocrystals can be further coated with one or more inorganic layers comprising one or more material such as a silicon oxide, an aluminum oxide, or a titanium oxide (e.g., SiO₂, Si₂O₃, TiO₂, or Al₂O₃), to hermetically seal the quantum dots.

In some embodiments, the quantum dots comprise ligands conjugated to, cooperated with, associated with, or attached to their surface. In some embodiments, the quantum dots include a coating layer comprising ligands to protect the quantum dots from external moisture and oxidation, to control aggregation, and to allow for dispersion of the quantum dots in the matrix material. Suitable ligands include those disclosed in U.S. Pat. Nos. 6,949,206; 7,267,875; 7,374,807; 7,572,393; 7,645,397; and 8,563,133 and in U.S. Patent Appl. Publication Nos. 2008/237540; 2008/281010; and 2010/110728.

In some embodiments, the quantum dot comprises a multi-part ligand structure, such as the three-part ligand structure disclosed in U.S. Patent Appl. Publication No. 2008/237540, in which the head-group, tail-group, and middle/body group are independently fabricated and optimized for their particular function, and then combined into an ideally functioning complete surface ligand.

In some embodiments, the ligands comprise one or more organic polymeric ligands.

Suitable ligands provide: efficient and strong bonding quantum dot encapsulation with low oxygen permeability; precipitate or segregate into domain in the matrix material to form a discontinuous dual-phase or multi-phase matrix; disperse favorably throughout the matrix material; and are commercially available materials or can be easily formulated from commercially available materials.

In some embodiments, the ligand is a polymer, a glassy polymer, a silicone, a carboxylic acid, a dicarboxylic acid, a polycarboxylic acid, an acrylic acid, a phosphonic acid, a phosphonate, a phosphine, a phosphine oxide, a sulfur, or an amine.

In some embodiments, the population of quantum dots emits red, green, or blue light. In some embodiments, the respective portions of red, green, and blue light can be controlled to achieve a desired white point for the white light emitted by a display device incorporating a quantum dot film.

In some embodiments, the quantum dot composition comprises at least one population of quantum dot material. In some embodiments, the quantum dot composition comprises a population of between 1 and 5, between 1 and 4, between 1 and 3, between 1 and 2, between 2 and 5, between 2 and 4, between 2 and 3, between 3 and 5, between 3 and 4, or between 4 and 5 quantum dot materials. Any suitable ratio of the populations of quantum dots can be combined to create the desired quantum dot composition characteristics.

In some embodiments, the quantum dot composition comprises, as a weight percentage of the quantum dot composition, between 0.001% and 2%, between 0.001% and 1%, between 0.001% and 0.5%, between 0.001% and 0.1%, between 0.001% and 0.01%, between 0.01% and 2%, between 0.01% and 1%, between 0.01% and 0.5%, between 0.01% and 0.1%, between 0.1% and 2%, between 0.1% and 1%, between 0.1% and 0.5%, between 0.5% and 2%, between 0.5% and 1%, or between 1% and 2% of quantum dots.

In some embodiments, the quantum dot molded article comprises, as a weight percentage of the quantum dot molded article, between 0.001% and 2%, between 0.001% and 1%, between 0.001% and 0.5%, between 0.001% and 0.1%, between 0.001% and 0.01%, between 0.01% and 2%, between 0.01% and 1%, between 0.01% and 0.5%, between 0.01% and 0.1%, between 0.1% and 2%, between 0.1% and 1%, between 0.1% and 0.5%, between 0.5% and 2%, between 0.5% and 1%, or between 1% and 2% of quantum dots.

### Siloxane Polymer

In some embodiments, the quantum dots are dispersed in a siloxane polymer. In some embodiments, the siloxane polymer is an aminosilicone polymer.

Siloxane polymers are characterized by having an —Si—O—Si— backbone, and are represented by the general formula —Si(R^{A}₂)O—, where the R^{A} groups can be the same or different, and can be any suitable group, including, but not limited to, hydrogen, alkyl, heteroalkyl, alkylamine, carboxyalkyl, alkenyl, alkynyl, cycloalkyl, heterocycloalkyl, aryl, and heteroaryl. The siloxane polymers can be linear, branched, or cyclic. The siloxane polymer can include a single type of monomer repeat unit, forming a homopolymer. Alternatively, the siloxane polymer can include two or more types of monomer repeat units to form a copolymer that can be a random copolymer or a block copolymer.

In some embodiments, the siloxane polymer contains ligands suitable for binding to quantum dots. Suitable ligands include, but are not limited to, amine, carboxy, and thiol groups, capable of binding to the quantum dot via hydrogen-bonding, hydrophobic interactions, or van der Waal's forces. In some embodiments, the siloxane polymer includes amine binding groups as the ligands. In some embodiments, the siloxane polymer includes amine and carboxy binding groups as the ligands.

In some embodiments, when the quantum dots are dispersed in the siloxane polymer, ligands on the siloxane polymer bind to the quantum dots.

In some embodiments, the FGEW of the siloxane polymer is from about 1,000 g/mol to about 2,000 g/mol, from about 1,000 g/mol to 1,600 g/mol, from about 1,000 g/mol to about 1,400 g/mol, from about 1,400 g/mol to about 2,000 g/mol, from about 1,400 g/mol to about 1,600 g/mol, or from about 1,600 g/mol to about 2,000 g/mol. In some embodiments, the FGEW of the siloxane polymer has an FGEW of 1,200, 1,250, 1,300, 1,400, 1,500, 1,600, 1,700, or 1,800 g/mol. In some embodiments, the FGEW of the siloxane polymer is from about 1,250 to about 1,800 g/mol.

In some embodiments, the siloxane polymer is a commercially available siloxane polymer.

In some embodiments, the siloxane polymer is a commercially available aminosilicone polymer.

In some embodiments, the siloxane polymer is SF1708 (Momentive Performance Materials Inc., Waterford, N.Y.). SF1708 is an aminopropylaminoethylpolysiloxane which has a FGEW of 1,250 g/mol, a molecular weight from 25,000 to 30,000 Daltons, and a viscosity of 1250-2500 centipoise at 25° C.

In some embodiments, the siloxane polymer is KF-393, KF-859, KF-860, KF-861, KF-867, KF-869, KF-880, KF-8002, KF-8004, KF-8005, or KF-8021 (Shin-Etsu Chemical Co., Ltd, Tokyo, Japan). KF-393 has a FGEW of 350 g/mol, a viscosity of 70 mm²/s, a specific gravity of 0.98, and a refractive index of 1.422, all at 25° C. KF-859 has a FGEW of 6,000 g/mol, a viscosity of 60 mm²/s, a specific gravity of 0.96, and a refractive index of 1.403, all at 25° C. KF-860 has a FGEW of 7,600 g/mol, a viscosity of 250 mm²/s, a specific gravity of 0.97, and a refractive index of 1.404, all at 25° C. KF-861 has a FGEW of 2,000 g/mol, a viscosity of 3,500 mm²/s, a specific gravity of 0.98, and a refractive index of 1.408, all at 25° C. KF-867 has a FGEW of 1,700 g/mol, a viscosity of 1,300 mm²/s, a specific gravity of 0.98, and a refractive index of 1.407, all at 25° C. KF-869 has a FGEW of 3,800 g/mol, a viscosity of 1,500 mm²/s, a specific gravity of 0.97, and a refractive index of 1.405, all at 25° C. KF-880 has a FGEW of 1,800 g/mol, a viscosity of 650 mm²/s, a specific gravity of 0.98, and a refractive index of 1.407, all at 25° C. KF-8002 has a FGEW of 1,700 g/mol, a viscosity of 1,100 mm²/s, a specific gravity of 0.98, and a refractive index of 1.408, all at 25° C. KF-8004 has a FGEW of 1,500 g/mol, a viscosity of 800 mm²/s, a specific gravity of 0.98, and a refractive index of 1.408, all at 25° C. KF-8005 has a FGEW of 11,000 g/mol, a viscosity of 1,200 mm²/s, a specific gravity of 0.97, and a refractive index of 1.403, all at 25° C. KF-8021 has a FGEW of 55,000 g/mol, a viscosity of 15,000 mm²/s, a specific gravity of 0.97, and a refractive index of 1.403, all at 25° C.

In some embodiments, the siloxane polymer is OFX-8417, BY 16-849, FZ-3785, BY 16-872, or BY 16-853 U (Dow Corning Toray Co., Ltd., Japan). OFX-8417 has a FGEW of 1,700 g/ml and a viscosity of 1,200 m²/s, all at 25° C. BY 16-849 has a FGEW of 600 g/ml and a viscosity of 1,200 m²/s, all at 25° C. FZ-3785 has a FGEW of 6,000 g/ml and a viscosity of 3,500 m²/s, all at 25° C. BY 16-872 has a FGEW of 1,800 g/ml and a viscosity of 18,100 m²/s, all at 25° C. BY 16-853 has a FGEW of 450 g/ml and a viscosity of 14 m²/s, all at 25° C.

In some embodiments, the siloxane polymer is an amine-terminated siloxane such as DMS-A11, DMS-A12, DMS-A15, DMS-A21, DMS-A31, DMS-A32, DMS-A35, DMS-A211, or DMS-A214 (Gelest, Inc., Morrisville, Pa.). In some embodiments, the siloxane polymer has a pendant amine functionality such as AMS-132, AMS-152, AMS-162, AMS-233, AMS-242, ATM-1112, ATM-1322, UBS-0541, or UBS-0822 (Gelest, Inc., Morrisville, Pa.).

In some embodiments, the siloxane polymer is an amine-terminated siloxane such as GP-657, GP-RA-157, GP-34, GP-397, GP-145, GP-871, or GP-846 (Genesee Polymers, Flint, Mich.). In some embodiments, the siloxane polymer has a pendant amine functionality such as GP-4, GP-6, GP-581, GP-344, GP-342, GP-316, or GP-345 (Genesee Polymers, Flint, Mich.).

In some embodiments, the siloxane polymer can be prepared using methods known to one of skill in the art. In some embodiments, the siloxane polymer is prepared using the methods disclosed in U.S. Pat. No. 9,139,770, incorporated herein by reference in its entirety.

In some embodiments, the siloxane polymer contains a plurality of monomer repeat units. In some embodiments, the siloxane polymer contains a plurality of amine binding groups each covalently attached to one of the monomer repeat units, thereby forming a first population of monomer repeat units. In some embodiments, the siloxane polymer also includes a plurality of solubilizing groups each covalently attached to one of the monomer repeat units, thereby forming a second population of monomer repeat units.

In some embodiments, the siloxane polymer includes a plurality of alkylamine binding groups each covalently attached to one of the monomer repeat units, thereby forming a first population of monomer repeat units. In some embodiments, the siloxane polymer also includes a plurality of solubilizing or hydrophobic groups each covalently attached to one of the monomer repeat units, thereby forming a second population of monomer repeat units.

In some embodiments, the siloxane polymer has a waxy component and an amine binding component. The waxy component can be any solubilizing or hydrophobic group. In some embodiments, the solubilizing or hydrophobic group can be a long-chain alkyl group, a long-chain alkenyl group, a long-chain alkynyl group, a cycloalkyl, or an aryl. In some embodiments, the solubilizing or hydrophobic group can be a C₈₋₂₀ alkyl, a C₈₋₂₀ alkenyl, a C₈₋₂₀ alkynyl, a C₃₋₁₂ cycloalkyl, or a C₆₋₁₆ aryl.

In some embodiments, the solubilizing group or waxy component can be a long-chain alkyl. In some embodiments, each long-chain alkyl group can be octyl, nonyl, decyl, undecyl, dodecyl, tridecyl, tetradecyl, pentadecyl, hexadecyl, heptadecyl, octadecyl, nonadecyl, or icosyl. In some embodiments, each long-chain alkyl group can be hexadecyl, heptadecyl, octadecyl, nonadecyl, or icosyl. In some embodiments, each long-chain alkyl group can be hexadecyl, octadecyl, or icosyl. In some embodiments, each long-chain alkyl group can be octadecyl. The long-chain alkyl group can be linear or branched, and optionally substituted.

The siloxane polymer can have any suitable number of monomer repeat units. In some embodiments, the siloxane polymer can include between about 5 to about 100, about 5 to about 50, about 5 to about 40, about 5 to about 30, about 5 to about 20, about 5 to about 10, about 10 to about 100, about 10 to about 50, about 10 to about 40, about 10 to about 30, about 10 to about 20, about 20 to about 100, about 20 to about 50, about 20 to about 40, about 20 to about 30, about 30 to about 100, about 30 to about 50, about 30 to about 40, about 40 to about 100, about 40 to about 50, or about 50 to about 100 monomer repeat units. In some embodiments, the siloxane polymer can include about 5, 10, 15, 20, 25, 30, 40, 50, 60, 70, 80, 90 or 100 monomer repeat units.

When there are at least two types of monomer repeat units, one type of monomer repeat can be present in a greater amount relative to the other types of monomer repeat units. Alternatively, the different types of monomer repeat units can be present in about the same amount. In some embodiments, the first population of monomer repeat units is about the same number as the second population of monomer repeat units.

Each monomer repeat unit can be the same or different. In some embodiments, there are at least two types of monomer repeat units in the siloxane polymer. In some embodiments, the siloxane polymer includes at least two types of monomer repeat units where a first type includes a long-chain alkyl group and a second type includes an alkylamine binding group. Other types of monomer repeat units can also be present. The siloxane polymer of the present invention can include 1, 2, 3, 4, or more different kinds of monomer repeat units. In some embodiments, the siloxane polymers of the present invention have a single type of monomer repeat unit. In some embodiments, the siloxane polymers of the present invention have two different types of monomer repeat units.

In some embodiments, each monomer repeat unit is covalently linked to both the amine binding group and the long-chain alkyl group, such that the first and second populations of monomer repeat units are the same.

In some embodiments, each monomer repeat unit is covalently linked to both the alkylamine binding group and the long-chain alkyl group, such that the first and second populations of monomer repeat units are the same.

In some embodiments, the siloxane polymer has the structure of formula I:

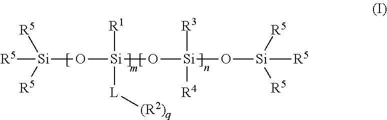

wherein each R¹ can independently be C₁₋₂₀ alkyl, C₁₋₂₀ heteroalkyl, C₂₋₂₀ alkenyl, C₂₋₂₀ alkynyl, cycloalkyl, or aryl, each optionally substituted with one or more —Si(R^{1a})₃ groups; each R^{1a} can independently be C₁₋₆ alkyl, cycloalkyl, or aryl; each L can independently be C₃₋₈ alkylene, C₃₋₈ heteroalkylene, C₃₋₈ alkylene-O—C₂₋₈ alkylene, C₃₋₈ alkylene-(C(O)NH—C₂₋₈ alkylene)_{q}, C₃₋₈ heteroalkylene-(C(O)NH—C₂₋₈ alkylene)_{q}, or C₃₋₈ alkylene-O—C₃₋₈ alkylene-(C(O)NH—C₂₋₈ alkylene)_{q}; each R² can independently be NR^{2a}R^{2b} or C(O)OH; each of R^{2a} and R^{2b} can independently be H or C₁₋₆ alkyl; each R³ can independently be C₁₋₂₀ alkyl, C₂₋₂₀ alkenyl, C₂₋₂₀ alkynyl, cycloalkyl, or aryl; each R⁴ can independently be C₈₋₂₀ alkyl, C₈₋₂₀ heteroalkyl, cycloalkyl, or aryl, each optionally substituted with one or more —Si(R^{1a})₃ groups; each R⁵ can independently be C₁₋₂₀ alkyl, C₂₋₂₀ alkenyl, C₂₋₂₀ alkynyl, -L-(R²)_{q}, cycloalkyl, or aryl; subscript m is an integer from 5 to 50; subscript n is an integer from 0 to 50; and subscript q is an integer from 1 to 10, wherein when subscript n is 0, then R¹ can be C₈₋₂₀ alkyl, C₈₋₂₀ heteroalkyl, C₈₋₂₀ alkenyl, C₈₋₂₀ alkynyl, cycloalkyl, or aryl, each optionally substituted with one or more —Si(R^{1a})₃ groups.

In some embodiments, each R¹ can independently be C₁₋₂₀ alkyl, C₁₋₂₀ heteroalkyl, C₂₋₂₀ alkenyl, C₂₋₂₀ alkynyl, cycloalkyl, or aryl; each R^{1a} can independently be C₁₋₆ alkyl, cycloalkyl, or aryl; each L can independently be C₃₋₈ alkylene; each R² can independently be NR^{2a}R^{2b} or C(O)OH; each of R^{2a} and R^{2b} can independently be H or C₁₋₆ alkyl; each R³ can independently be C₁₋₂₀ alkyl, C₂₋₂₀ alkenyl, C₂₋₂₀ alkynyl, cycloalkyl, or aryl; each R⁴ can independently be C₈₋₂₀ alkyl, C₈₋₂₀ heteroalkyl, cycloalkyl, or aryl; each R⁵ can independently be C₁₋₂₀ alkyl, C₂₋₂₀ alkenyl, C₂₋₂₀ alkynyl, -L-(R²)_{q}, cycloalkyl, or aryl; subscript m is an integer from 5 to 50; subscript n is an integer from 0 to 50; and subscript q is an integer from 1 to 10, wherein when subscript n is 0, then R¹ can be C₈₋₂₀ alkyl, C₈₋₂₀ heteroalkyl, C₈₋₂₀ alkenyl, C₈₋₂₀ alkynyl, cycloalkyl, or aryl.

Radical L can be any suitable linker to link the binding group R² to the siloxane polymer. In some embodiments, each L can independently be C₃₋₈ alkylene, C₃₋₈ alkylene-O—C₂₋₈ alkylene, C₃₋₈ alkylene-(C(O)NH—C₂₋₈ alkylene)₂, or C₃₋₈ alkylene-O—C₁₋₈ alkylene-(C(O)NH—C₂₋₈ alkylene)₃. In other embodiments, each L can independently be C₃₋₈ alkylene. In some other embodiments, each L can independently be propylene, butylene, pentylene, n-propylene-O-i-propylene, or pentylene-(C(O)NH-ethylene)₂. In still other embodiments, each L can independent be propylene, butylene, or pentylene.

The binding group, R², can be any suitable amine or carboxylic acid. For example, R² can be a primary amine where both of R^{2a} and R^{2b} are H. Alternatively, R² can be a secondary amine where one of R^{2a} and R^{2b} is H and the other is C₁₋₆ alkyl. Representative secondary amines include, but are not limited to, those where R^{2a} is methyl, ethyl, propyl, isopropyl, butyl, or pentyl. Tertiary amines, where each of R^{2a} and R^{2b} is C₁₋₆ alkyl, are also useful as the binding group R². In embodiments where each of R^{2a} and R^{2b} is C₁₋₆ alkyl, the R^{2a} and R^{2b} can be the same or different. In some embodiments, the tertiary amine is N(CH₃)₂, —N(CH₂CH₃)₂, —N(CH₂CH₂CH₃)₂, —N(CH₃)(CH₂CH₃), N(CH₃)(CH₂CH₂CH₃), or —N(CH₂CH₃)(CH₂CH₂CH₃).

In some embodiments, each -L-(R²)_{q} group can independently be C₃₋₈ alkylene-(R²)₁₋₃, C₃₋₈ heteroalkylene-R², or C₃₋₈ alkylene-(C(O)NH—C₂₋₈ alkylene-R²)₂. In some embodiments, each L-(R²)_{q} group can independently be C₃₋₈ alkylene-C(O)OH, C₃₋₈ alkylene-(C(O)OH)₂, C₃₋₈ alkylene-O—C₂₋₈ alkylene-(C(O)OH)₃, C₃₋₈ alkylene-NR^{2a}R^{2b}, or C₃₋₈ alkylene-(C(O)NH—C₂₋₈ alkylene-NR^{2a}R^{2b})₂. In some embodiments, each L-(R²)_{q} group can independently be C₃₋₈ alkylene-C(O)OH, C₃₋₈ alkylene-(C(O)OH)₂, or C₃₋₈ alkylene-NR^{2a}R^{2b}.

In some embodiments, each L-(R²)_{q} group can independently be:

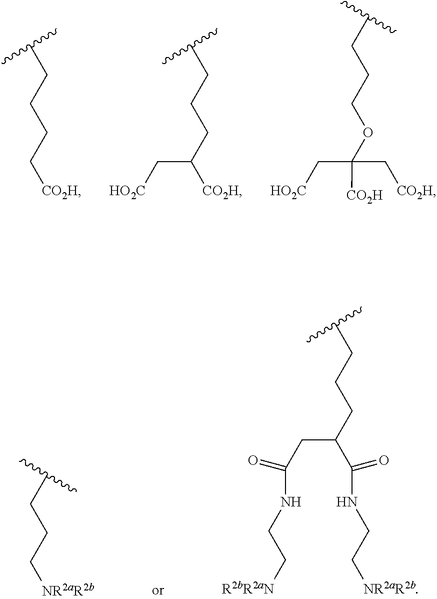

In some embodiments, each L-(R²)_{q} group can independently be:

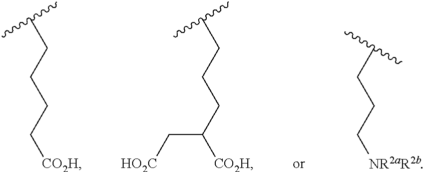

One of radicals R¹ and R⁴ can be the solubilizing group. When subscript n is 0, R¹ can be the solubilizing group. When subscript n is greater than 1, either of R¹ and R⁴ can be the solubilizing group. Any suitable solubilizing group can be used in the present invention. In some embodiments, at least one of R¹ and R⁴ can be C₈₋₂₀ alkyl or C₈₋₂₀ heteroalkyl, wherein each alkyl group is optionally substituted with one —Si(R^{1a})₃ group. In some embodiments, at least one of R¹ and R⁴ can be a solubilizing group such as a C₈₋₂₀ alkyl or C₈₋₂₀ heteroalkyl. In some embodiments, at least one of R¹ and R⁴ can be C₁₆ alkyl, C₁₈ alkyl, C₂₀ alkyl, or —(CH₂)₂—(OCH₂CH₂)₃—OCH₃, wherein each alkyl group is optionally substituted with one —Si(R^{1a})₃ group. In some embodiments, at least one of R¹ and R⁴ can be C₁₆ alkyl, C₁₈ alkyl, C₂₀ alkyl, or —(CH₂)₂—(OCH₂CH₂)₃—OCH₃.

When the alkyl group of R¹ or R⁴ is substituted with the —Si(R^{1a})₃ group, the substitution can be at any point on the alkyl group, including the terminal carbon, or any other carbon in the alkyl chain. The alkyl group can be branched or unbranched. The R^{1a} group can be any suitable group that promotes solubilization of the siloxane polymer. For example, each R^{1a} can independently be C₁₋₆ alkyl, cycloalkyl, or aryl. Each R^{1a} can be the same or different. In some embodiments, each R^{1a} can independently be C₁₋₆ alkyl. The alkyl groups of R^{1a} can be branched or unbranched. In some embodiments, the alkyl groups of R^{1a} are methyl, ethyl, or propyl. In some embodiments, each R^{1a} can be ethyl.

Radical R³ can be any suitable group. In some embodiments, each R³ can independently be C₁₋₂₀ alkyl, C₂₋₂₀ alkenyl, C₂₋₂₀ alkynyl, cycloalkyl, or aryl. In other embodiments, each R³ can independently be C₁₋₂₀ alkyl. In some embodiments, each R³ can independently be C₁₋₆ alkyl. In some embodiments, each R³ can independently be C₁₋₃ alkyl. In some embodiments, each R³ can independently be methyl, ethyl, or propyl. In some embodiments, each R³ can be methyl.

R⁵ can be any suitable group. In some embodiments, each R⁵ can independently be C₁₋₂₀ alkyl, C₂₋₂₀ alkenyl, C₂₋₂₀ alkynyl, -L-(R²)_{q}, cycloalkyl, or aryl. In other embodiments, each R⁵ can independently be C₁₋₂₀ alkyl. In some embodiments, each R⁵ can independently be C₁₋₆ alkyl. In some embodiments, each R⁵ can independently be C₁₋₃ alkyl. In yet other embodiments, each R⁵ can independently be methyl, ethyl, or propyl. In some embodiments, each R⁵ can be methyl.

In some embodiments, R⁵ can be an amine or carboxy binding group, or a solubilizing group. In some embodiments, at least one R⁵ can be -L-(R²)_{q}, as defined above. In some embodiments, at least one R⁵ can be C₈₋₂₀ alkyl. In some embodiments, at least one R⁵ can be C₁₂₋₂₀ alkyl. In some embodiments, at least one R⁵ can be octadecyl.

When the siloxane polymers of the present invention have two types of monomer repeat units, such that subscript n is not 0, the structure can be the structure of formula I, wherein each R⁵ can independently be C₁₋₂₀ alkyl, C₂₋₂₀ alkenyl, C₂₋₂₀ alkynyl, cycloalkyl, or aryl; subscript m can be an integer from 5 to 50; and subscript n can be an integer from 1 to 50. In some embodiments, R¹ can independently be C₁₋₃ alkyl. In some embodiments, the alkyl groups of R⁴ can be C₈₋₂₀ alkyl, C₁₂₋₂₀ alkyl, C₁₄₋₂₀ alkyl, C₁₆₋₂₀ alkyl, or C₁₈₋₂₀ alkyl.

In some embodiments, each R⁵ can independently be C₁₋₂₀ alkyl, C₂₋₂₀ alkenyl, C₂₋₂₀ alkynyl, cycloalkyl, or aryl; subscript m can be an integer from 5 to 50; and subscript n can be 0. In some embodiments, each R¹ can independently be C₈₋₂₀ alkyl or C₈₋₂₀ heteroalkyl, wherein the alkyl group can optionally be substituted with one —Si(R^{1a})₃ group; each R^{1a} can independently be C₁₋₆ alkyl; each R⁵ can independently be C₁₋₃ alkyl; and subscript q can be an integer from 1 to 3. In some embodiments, each R¹ can independently be C₈₋₂₀ alkyl or C₈₋₂₀ heteroalkyl; each R^{1a} can independently be C₁₋₆ alkyl; each R⁵ can independently be C₁₋₃ alkyl; and subscript q can be an integer from 1 to 3.

Any suitable number of subscripts m and n can be present in the siloxane polymers of the present invention. For example, subscripts m and n can be from about 1 to about 100, from about 1 to about 80, from about 1 to about 60, from about 1 to about 40, from about 1 to about 20, from about 1 to about 10, from about 5 to about 100, from about 5 to about 80, from about 5 to about 60, from about 5 to about 40, from about 5 to about 40, from about 5 to about 20, from about 5 to about 10, from about 10 to about 100, from about 10 to about 80, from about 10 to about 60, from about 10 to about 40, from about 10 to about 20, from about 20 to about 100, from about 20 to about 80, from about 20 to about 60, from about 20 to about 40, from about 40 to about 100, from about 40 to about 80, from about 40 to about 60, from about 60 to about 100, from about 60 to about 80, or from about 80 to about 100. Alternatively, subscripts m and n can be about 5, 10, 15, 20, 25, 30, 40, 50, 60, 70, 80, 90, or 100.

Any suitable ratio of subscripts m and n can be present in the quantum dot binding-ligands of the present invention. When m and n are both greater than 0, the ratio of subscript m to n can be about 100:1, 90:1, 80:1, 75:1, 70:1, 60:1, 50:1, 40:1, 30:1, 25:1, 20:1, 15:1 10:1, 5:1, 4:1, 3:1, 2.5:1 2:1, 1:1, 1:2, 1:2.5, 1:3, 1:4, 1:5, 1:10, 1:15, 1:20, 1:25, 1:30, 1:40, 1:50, 1:60, 1:70, 1:75, 1:80, 1:90 or 1:100. In some embodiments, the ratio of subscript m to subscript n is from about 1:100 to about 1:1. In some embodiments, the ratio of subscript m to subscript n is from about 1:100 to about 1:10. In some embodiments, the ratio of subscript m to subscript n is from about 1:50 to about 1:10. In some embodiments, the ratio of subscript m to subscript n is about 1:20.

In some embodiments, R¹ and R³ can each independently be C₁₋₃ alkyl; each R^{1a} can independently be C₁₋₆ alkyl; each R⁴ can independently be C₈₋₂₀ alkyl or C₈₋₂₀ heteroalkyl, wherein the alkyl group can optionally be substituted with one —Si(R^{1a})₃ group; each R⁵ can independently be C₁₋₃ alkyl; and subscript q can be an integer from 1 to 3.

In some embodiments, wherein R¹, R³, and R⁵ are methyl and subscript n is other than 0, the siloxane polymer of formula I has the structure of formula Ia:

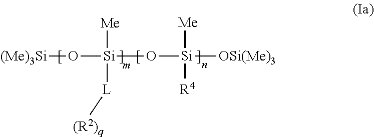

wherein subscript m is an integer from 5 to 14, subscript n is an integer from 1 to 14, R² is NR^{2a}R^{2b} or C(O)OH, and L, q, R^{2a}, R^{2b}, and R⁴ are as defined for formula I. In some embodiments, the siloxane polymer of formula Ia has the following structure:

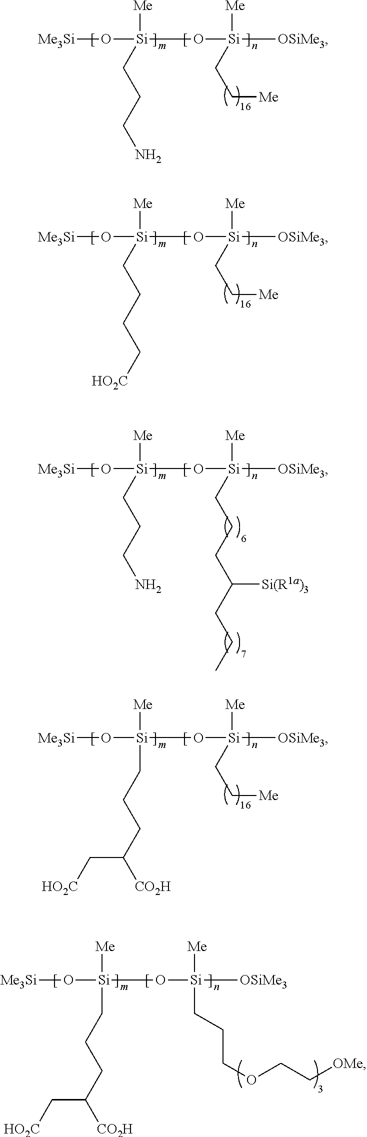

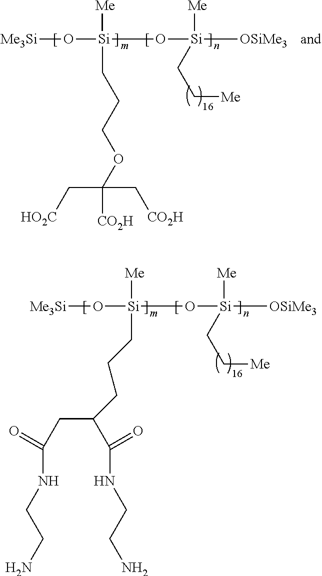

wherein subscript m is an integer from 10 to 14, subscript n is an integer from 1 to 14, and R^{1a} is as defined for formula I.

In some embodiments, the siloxane polymer of formula Ia has the following structure:

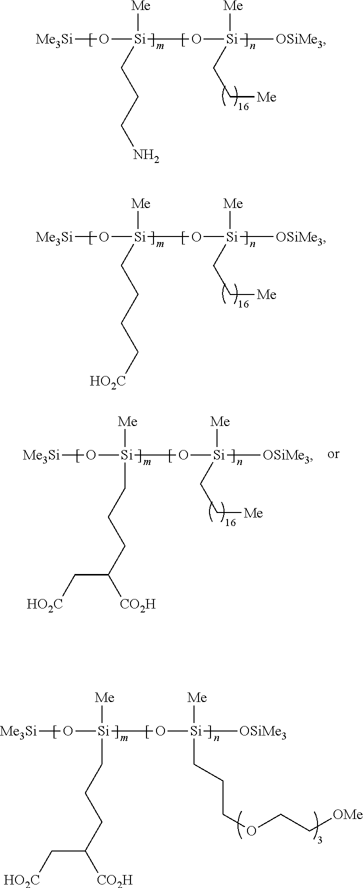

wherein subscript m is an integer from 10 to 14 and subscript n is an integer from 1 to 14.

In some embodiments, where R⁵ is methyl and subscript n is 0, the siloxane polymer of formula I has the structure of formula Ib:

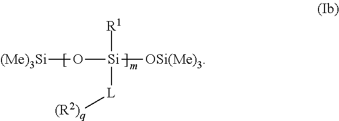

wherein R¹, R², m, q, and L are as defined for formula I.

In some embodiments, R¹ can be C₈₋₂₀ alkyl. In some embodiments, where R¹ is C₁₈ alkyl, the siloxane polymer of formula Ib has the following structure:

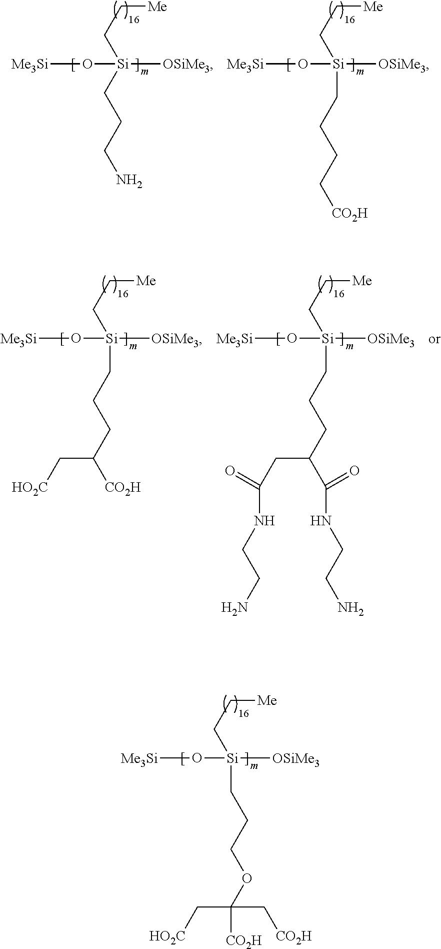

wherein subscript m is an integer from 5 to 50.

In some embodiments, where R¹ is C₁₈ alkyl, the siloxane polymer of formula Ib has the following structure:

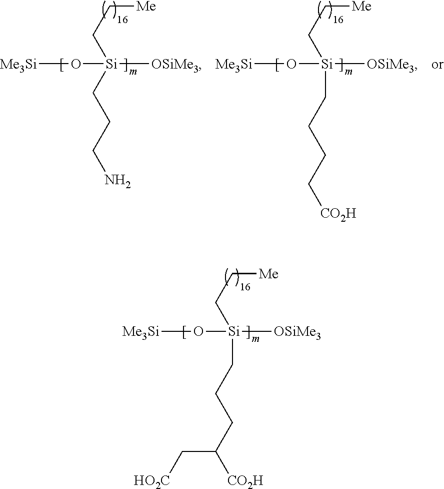

wherein subscript m is an integer from 5 to 50.

In some embodiments, where -L-(R²)_{q} is R⁶ the siloxane polymer of formula I has the structure of formula Ic:

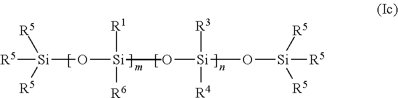

wherein each R¹ can independently be C₁₋₂₀ alkyl, C₂₋₂₀ alkenyl, C₂₋₂₀ alkynyl, cycloalkyl, or aryl, wherein the alkyl group is optionally substituted with one —Si(R^{1a})₃ group 1; each R⁶ can independently be C₃₋₈ alkylene-NR^{2a}R^{2b}; each of R^{2a} and R^{2b} can independently be H or C₁₋₆ alkyl; each R³ can independently be C₁₋₂₀ alkyl, C₂₋₂₀ alkenyl, C₂₋₂₀ alkynyl, cycloalkyl, or aryl; each R⁴ can independently be C₈₋₂₀ alkyl; each R⁵ can independently be C₁₋₂₀ alkyl, C₂₋₂₀ alkenyl, C₂₋₂₀ alkynyl, C₃₋₈ alkylene-NR^{2a}R²¹), cycloalkyl, or aryl; subscript m can be an integer from 5 to 50; and subscript n can be an integer from 0 to 50; wherein when subscript n is 0, then R¹ can be C₈₋₂₀ alkyl, C₈₋₂₀ alkenyl, C₈₋₂₀ alkynyl, cycloalkyl, or aryl. In some embodiments, the alkyl groups of R¹ or R⁴ can be C₈₋₂₀ alkyl, C₁₂₋₂₀ alkyl, C₁₄₋₂₀ alkyl, C₁₆₋₂₀ alkyl, or C₁₈₋₂₀ alkyl.

Radical R⁵ can be any suitable group. In some embodiments, each R⁵ can independently be C₁₋₂₀ alkyl, C₂₋₂₀ alkenyl, C₂₋₂₀ alkynyl, C₃₋₈ alkyl-NR^{2a}R^{2b}, cycloalkyl, or aryl. In some embodiments, each R⁵ can independently be C₁₋₂₀ alkyl, C₂₋₂₀ alkenyl, C₂₋₂₀ alkynyl, cycloalkyl, or aryl. In some embodiments, each R⁵ can be C₁₋₂₀ alkyl. In some embodiments, each R⁵ can be C₈₋₂₀ alkyl. In some embodiments, each R⁵ can be octadecyl. In some embodiments, each R⁵ can be C₁₋₃ alkyl. In some embodiments, each R⁵ can independently be methyl, ethyl, or propyl. In some embodiments, each R⁵ can be aryl. In some embodiments, each R⁵ can be phenyl. In some embodiments, each R⁵ can be C₃₋₈ alkyl-NR^{2a}R^{2b}. In some embodiments, each R⁵ can be C₃ alkylene-NR^{2a}R^{2b}. In some embodiments, each R⁵ can independently be octadecyl or C₃ alkylene-NR^{2b}R^{2b}.

In some embodiments, where R⁶ is (CH₂)ₚCH₂CH₂NR^{2a}R^{2b}), the siloxane polymer of formula 1c has the structure of formula Id:

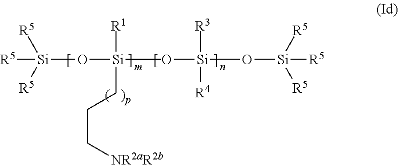

wherein R¹, R^{2a}, R^{2b}, R³, R⁴, and R⁵ are as defined above for formula Ic, subscripts m and n are each an integer from 10 to 14, and subscript p is an integer from 1 to 6.

In some embodiments, where R¹, R³, and R⁵ are methyl, R⁴ is C₁₈ alkylene, and R⁶ is (CH₂)ₚCH₂CH₂NR^{2a}R^{2b}), the siloxane polymer of formula Ic has the structure of formula Ie:

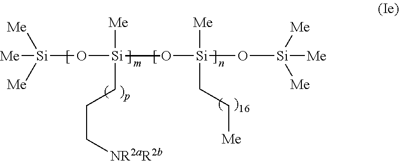

wherein R^{2a} and R^{2b} are as defined above for formula Ic, subscripts m and n are each an integer from 10 to 14, and subscript p is an integer from 1 to 6.

When the siloxane polymer of the present invention has a single type of monomer repeat unit, such that subscript n is 0, the structure can be the structure of formula I, wherein each R¹ can independently be C₈₋₂₀ alkyl, C₈₋₂₀ alkenyl, C₈₋₂₀ alkynyl, cycloalkyl, or aryl. In some embodiments, each R¹ can independently be C₈₋₂₀ alkyl; subscript m can be an integer from 5 to 50; and subscript n can be 0.

In some embodiments, where n is 0, the siloxane polymer of formula Ic can have the structure of formula If:

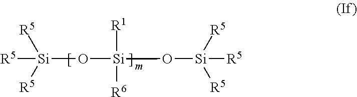

wherein R¹, R⁵, and R⁶ are as defined above for formula Ic and subscript m is an integer from 10 to 14.

In some embodiments, where subscript n is 0 and R⁶ is (CH₂)ₚCH₂CH₂NR^{2a}R^{2b}, the siloxane polymer of formula Ic can have the structure of formula Ig:

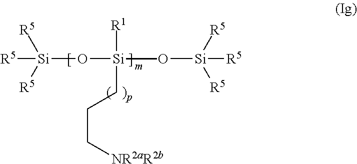

wherein R¹, R^{2a}, R^{2b}, and R⁵ are as defined above for formula Ic, subscript m is an integer from 10 to 14, and subscript p is an integer from 1 to 6. In some embodiments, subscript p can be 1, 2, 3, 4, 5, or 6. In some embodiments, subscript p can be 1.

In some embodiments, where subscript n is 0, R¹ is C₁₈ alkyl, R⁶ is CH₂CH₂CH₂NR^{2a}R^{2b}, and R⁵ is methyl, the siloxane polymer of formula Ic can have the structure of formula Ih:

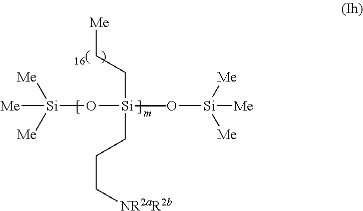

wherein R^{2a} and R^{2b} are as defined above for formula Ic and subscript m is an integer from 10 to 14.

In some embodiments, each R⁵ can independently be C₈₋₂₀ alkyl, C₈₋₂₀ alkenyl, C₈₋₂₀ alkynyl, C₃₋₈ alkylene-NR^{2b}R^{2b}, cycloalkyl, or aryl. In some embodiments, each R⁵ can independently be C₈₋₂₀ alkyl or C₃₋₈ alkylene-NR^{2b}R^{2b}.

In some embodiments, where subscript n is 0, R¹ and R⁵ are C₁₈ alkyl, and R⁶ is CH₂CH₂CH₂NR^{2a}R^{2b}, the siloxane polymer of formula Ic can have the structure of formula Ii:

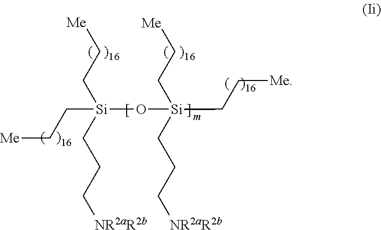

Whether the siloxane polymer is obtained from a commercial source or prepared de novo, the siloxane polymer can be of any suitable molecular weight, glass transition temperature, and viscosity.

The siloxane polymer can have any suitable molecular weight. In some embodiments, the siloxane polymer has a molecular weight of between about 1000 Daltons (Da) to about 20 kDa, about 1000 Da to about 10 kDa, about 1000 Da to about 5 kDa, about 1000 Da to about 2 kDa, about 2 kDa to about 20 kDa, about 2 kDa to about 10 kDa, about 2 kDa to about 5 kDa, about 5 kDa to about 20 kDa, about 5 kDa to about 10 kDa, or about 10 kDa to about 20 kDa.

Siloxane polymers typically have a low glass transition temperature and a low viscosity, depending on the size of the polymer and the groups pendant to the polymer backbone. In some embodiments, the siloxane polymers can have a glass transition temperature of between about 1° C. to about 100° C., about 1° C. to about 60° C., about 1° C. to about 40° C., about 1° C. to about 20° C., about 10° C. to about 100° C., about 10° C. to about 60° C., about 10° C. to about 40° C., about 10° C. to about 20° C., about 20° C. to about 100° C., about 20° C. to about 60° C., about 20° C. to about 40° C., about 40° C. to about 100° C., about 40° C. to about 60° C., or about 60° C. to about 100° C. In some embodiments, the siloxane polymer has a glass transition temperature of 90, 80, 70, 60, 50, 40, 30, 25, 20, 15, 10, 5, or 0° C. In some embodiments, the siloxane polymer can have a glass transition temperature of less than about 50° C. In other embodiments, the siloxane polymer can have a glass transition temperature of less than about 25° C.

In some embodiments, the siloxane polymer can have any suitable viscosity. In some embodiments, the am siloxane polymer has a viscosity of between about 1 centistokes (cSt) to about 5000 cSt, about 1 cSt to about 1000 cSt, about 1 cSt to about 500 cSt, about 1 cSt to about 100 cSt, about 1 cSt to about 50 cSt, about 1 cSt to about 10 cSt, about 1 cSt to about 5 cSt, about 5 cSt to about 5000 cSt, about 5 cSt to about 1000 cSt, about 5 cSt to about 500 cSt, about 5 cSt to about 100 cSt, about 5 cSt to about 50 cSt, about 5 cSt to about 10 cSt, about 10 cSt to about 5000 cSt, about 10 cSt to about 1000 cSt, about 10 cSt to about 500 cSt, about 10 cSt to about 100 cSt, about 10 cSt to about 50 cSt, about 50 cSt to about 5000 cSt, about 50 cSt to about 1000 cSt, about 50 cSt to about 500 cSt, about 50 cSt to about 100 cSt, about 100 cSt to about 5000 cSt, about 100 cSt to about 1000 cSt, about 100 cSt to about 500 cSt, about 500 cSt to about 5000 cSt, about 500 cSt to about 1000 cSt, or about 1000 cSt to about 5000 cSt.

In some embodiments, when the quantum dots are dispersed in the siloxane polymer, the resultant composition has a higher viscosity than the siloxane polymer alone.

In some embodiments, the quantum dot composition comprises at least one siloxane polymer. In some embodiments, the quantum dot composition comprises between 1 and 5, between 1 and 4, between 1 and 3, between 1 and 2, between 2 and 5, between 2 and 4, between 2 and 3, between 3 and 5, between 3 and 4, or between 4 and 5 siloxane polymers.

The siloxane polymer can be present in any suitable amount. For example, the siloxane polymer can be present in an amount that is more than, about the same as, or less than (weight/weight) compared to the quantum dots. In some embodiments, the weight ratio of siloxane polymer to quantum dots is about 1000:1 to about 1:1000, about 1000:1 to about 1:500, about 1000:1 to about 1:200, about 1000:1 to about 1:100, about 1000:1 to about 1:50, about 1000:1 to about 1:10, about 1000:1 to about 1:1, about 500:1 to about 1:1000, about 500:1 to about 1:500, about 500:1 to about 1:200, about 500:1 to about 1:100, about 500:1 to about 1:50, about 500:1 to about 1:10, about 500:1 to about 1:1, about 200:1 to about 1:1000, about 200:1 to about 1:500, about 200:1 to about 1:200, about 200:1 to about 1:100, about 200:1 to about 1:50, about 200:1 to about 1:10, about 200:1 to about 1:1, about 100:1 to about 1:1000, about 100:1 to about 1:500, about 100:1 to about 1:200, about 100:1 to about 1:100, about 100:1 to about 1:50, about 100:1 to about 1:10, about 100:1 to about 1:1, about 50:1 to about 1:1000, about 50:1 to about 1:500, about 50:1 to about 1:200, about 50:1 to about 1:100, about 50:1 to about 1:50, about 50:1 to about 1:10, about 50:1 to about 1:1, about 10:1 to about 1:1000, about 10:1 to about 1:500, about 1:10, to about 1:200, about 10:1 to about 1:100, about 10:1 to about 1:50, about 10:1 to about 1:10, about 10:1 to about 1:1. In some embodiments, the weight ratio of siloxane polymer to quantum dots is about 1000:1, about 500:1, about 200:1, about 100:1, about 50:1, about 10:1, about 1:1, about 1:10, about 1:50, about 1:100, about 1:200, about 1:500, or about 1:1000.

In some embodiments, the quantum dot composition comprises as a weight percent of the quantum dot composition (weight/weight) between about 0.01% to about 50%, about 0.01% to about 25%, about 0.01% to about 20%, about 0.01% to about 15%, about 0.01% to about 10%, about 0.01% to about 5%, about 0.01% to about 2%, about 0.01% to about 1%, about 1% to about 50%, about 1% to about 25%, about 1% to about 20%, about 1% to about 15%, about 1% to about 10%, about 1% to about 5%, about 1% to about 2%, about 2% to about 50%, about 2% to about 25%, about 2% to about 20%, about 2% to about 15%, about 2% to about 10%, about 2% to about 5%, 5% to about 50%, about 5% to about 25%, about 5% to about 20%, about 5% to about 15%, about 5% to about 10%, about 10% to about 50%, about 10% to about 25%, about 10% to about 20%, about 10% to about 15%, about 15% to about 50%, about 15% to about 25%, about 15% to about 20%, about 20% to about 50%, about 20% to about 25%, or about 25% to about 50% of the siloxane polymer.

In some embodiments, the quantum dot composition comprises as a weight percent of the quantum dot molded article (weight/weight) between about 0.01% to about 50%, about 0.01% to about 25%, about 0.01% to about 20%, about 0.01% to about 15%, about 0.01% to about 10%, about 0.01% to about 5%, about 0.01% to about 2%, about 0.01% to about 1%, about 1% to about 50%, about 1% to about 25%, about 1% to about 20%, about 1% to about 15%, about 1% to about 10%, about 1% to about 5%, about 1% to about 2%, about 2% to about 50%, about 2% to about 25%, about 2% to about 20%, about 2% to about 15%, about 2% to about 10%, about 2% to about 5%, 5% to about 50%, about 5% to about 25%, about 5% to about 20%, about 5% to about 15%, about 5% to about 10%, about 10% to about 50%, about 10% to about 25%, about 10% to about 20%, about 10% to about 15%, about 15% to about 50%, about 15% to about 25%, about 15% to about 20%, about 20% to about 50%, about 20% to about 25%, or about 25% to about 50% of the siloxane polymer.

### Emulsification Additive

In some embodiments, an emulsification additive is added to a composition comprising quantum dots. In some embodiments, an emulsification additive is added to a composition comprising quantum dots dispersed in a polymer. In some embodiments, an emulsification additive is added to a composition comprising quantum dots dispersed in a solvent. In some embodiments, the emulsification additive improves the dispersibility of the quantum dots. In some embodiments, the emulsification additive increases the stability of the quantum dot compositions.

In some embodiments, the emulsification additive is selected from one of the following categories:
(1) organic backbone polymers with silicone side chains;
(2) silicone backbone polymers with organic side chains; and
(3) ABA linear block copolymers with an organic backbone polymer as block A and a silicone block backbone polymer as block B or with a silicone block backbone polymer as block A and an organic backbone polymer as block B.

In some embodiments, the emulsification additive does not comprise amine side chains, carboxylic acid side chains, epoxy side chains, or combinations thereof.

In some embodiments, the emulsification additive is a polymer with an ethylene oxide backbone, ethylene oxide side chains, or a combination thereof. In some embodiments, the emulsification additive is a polymer with a propylene oxide backbone, propylene oxide side chains, or a combination thereof.

In some embodiments, emulsification additive is a polydimethylsiloxane such as BYK-UV 3500, BYK-UV 3505, BYK-UV 3510, BYK-UV 3530, BYK-UV 3535, BYK-UV 3570, BYK-UV 3575, or BYK-UV 3576 (BYK Additives and Instruments, Germany).

In some embodiments, the emulsification additive is a silicone backbone polymer with organic side chains. In some embodiments, the emulsification additive is a silicone backbone polymer with ethylene oxide side chains. In some embodiments, the silicone backbone polymer with organic side chains is a dimethylsiloxane ethylene oxide block copolymer of formula II:

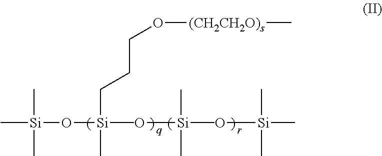

wherein subscripts q and r are integers from 1 to 50 and s is an integer from 1 to 20. In some embodiments, the emulsification additive is dimethylsiloxane-(25-30% ethylene oxide) block copolymer with a viscosity of 400 cSt (DBE-224, Gelest, Morrisville, Pa.). In some embodiments, the emulsification additive is dimethylsiloxane-(30-35% ethylene oxide) block copolymer with a viscosity of 10 cSt (DBE-311, Gelest, Morrisville, Pa.). In some embodiments, the emulsification additive is dimethylsiloxane-(45-50% ethylene oxide) block copolymer with a viscosity of 5-10 cSt (DBE-411, Gelest, Morrisville, Pa.). In some embodiments, the emulsification additive is dimethylsiloxane-(50-55% ethylene oxide) block copolymer with a viscosity of 100 cSt (DBE-621, Gelest, Morrisville, Pa.). In some embodiments, the emulsification additive is dimethylsiloxane-(60-70% ethylene oxide) block copolymer with a viscosity of 20 cSt (DBE-712, Gelest, Morrisville, Pa.). In some embodiments, the emulsification additive is dimethylsiloxane-(75% ethylene oxide) block copolymer with a viscosity of 30 cSt (DBE-713, Gelest, Morrisville, Pa.). In some embodiments, the emulsification additive is dimethylsiloxane-(80% ethylene oxide) block copolymer with a viscosity of 40-50 cSt (DBE-814, Gelest, Morrisville, Pa.). In some embodiments, the emulsification additive is dimethylsiloxane-(80-85% ethylene oxide) block copolymer with a viscosity of 100-120 cSt (DBE-821, Gelest, Morrisville, Pa.). In some embodiments, the emulsification additive is dimethylsiloxane-(85-90% ethylene oxide) block copolymer with a viscosity of 100-120 cSt (DBE-921, Gelest, Morrisville, Pa.).

In some embodiments, the emulsification additive contains ethylene oxide blocks. In some embodiments, the emulsification additive contains propylene oxide blocks. In some embodiments, the emulsification additive contains ethylene oxide blocks and propylene oxide blocks. In some embodiments, the emulsification additive is a silicone backbone polymer with ethylene oxide blocks and propylene oxide blocks.

In some embodiments, the ABA linear block copolymer is GP-675 or GP-690 (Genesee Polymer Corporation, Flint, Mich.).

Whether the emulsification additive is obtained from a commercial source or prepared de novo, the emulsification additive can be of any suitable molecular weight and viscosity.

The emulsification additive can have any suitable molecular weight. In some embodiments, the emulsification additive has a molecular weight of between about 100 Daltons (Da) to about 40 kDa, about 100 Da to about 20 kDa, about 100 Da to about 10 kDa, about 100 Da to about 5 kDa, about 100 Da to about 2 kDa, about 2 kDa to about 40 kDa, about 2 kDa to about 20 kDa, about 2 kDa to about 10 kDa, about 2 kDa to about 5 kDa, about 5 kDa to about 40 kDa, about 5 kDa to about 20 kDa, about 5 kDa to about 10 kDa, about 10 kDa to about 40 kDa, about 10 kDa to about 20 kDa, or about 20 kDa to about 40 kDa.

In some embodiments, the emulsification additive can have any suitable viscosity. In some embodiments, the emulsification additive has a viscosity of between about 1 centistokes (cSt) to about 5000 cSt, about 1 cSt to about 1000 cSt, about 1 cSt to about 500 cSt, about 1 cSt to about 100 cSt, about 1 cSt to about 50 cSt, about 1 cSt to about 10 cSt, about 1 cSt to about 5 cSt, about 5 cSt to about 5000 cSt, about 5 cSt to about 1000 cSt, about 5 cSt to about 500 cSt, about 5 cSt to about 100 cSt, about 5 cSt to about 50 cSt, about 5 cSt to about 10 cSt, about 10 cSt to about 5000 cSt, about 10 cSt to about 1000 cSt, about 10 cSt to about 500 cSt, about 10 cSt to about 100 cSt, about 10 cSt to about 50 cSt, about 50 cSt to about 5000 cSt, about 50 cSt to about 1000 cSt, about 50 cSt to about 500 cSt, about 50 cSt to about 100 cSt, about 100 cSt to about 5000 cSt, about 100 cSt to about 1000 cSt, about 100 cSt to about 500 cSt, about 500 cSt to about 5000 cSt, about 500 cSt to about 1000 cSt, or about 1000 cSt to about 5000 cSt.

In some embodiments, the quantum dot composition comprises at least one emulsification additive. In some embodiments, the quantum dot composition comprises between 1 and 5, between 1 and 4, between 1 and 3, between 1 and 2, between 2 and 5, between 2 and 4, between 2 and 3, between 3 and 5, between 3 and 4, or between 4 and 5 emulsification additives.

The emulsification additive can be present in any suitable amount. For example, the emulsification additive can be present in an amount that is more than, about the same as, or less than (weight/weight) compared to the quantum dots. In some embodiments, the weight ratio of emulsification additive to quantum dots is about 1000:1 to about 1:1000, about 1000:1 to about 1:500, about 1000:1 to about 1:200, about 1000:1 to about 1:100, about 1000:1 to about 1:50, about 1000:1 to about 1:10, about 1000:1 to about 1:1, about 500:1 to about 1:1000, about 500:1 to about 1:500, about 500:1 to about 1:200, about 500:1 to about 1:100, about 500:1 to about 1:50, about 500:1 to about 1:10, about 500:1 to about 1:1, about 200:1 to about 1:1000, about 200:1 to about 1:500, about 200:1 to about 1:200, about 200:1 to about 1:100, about 200:1 to about 1:50, about 200:1 to about 1:10, about 200:1 to about 1:1, about 100:1 to about 1:1000, about 100:1 to about 1:500, about 100:1 to about 1:200, about 100:1 to about 1:100, about 100:1 to about 1:50, about 100:1 to about 1:10, about 100:1 to about 1:1, about 50:1 to about 1:1000, about 50:1 to about 1:500, about 50:1 to about 1:200, about 50:1 to about 1:100, about 50:1 to about 1:50, about 50:1 to about 1:10, about 50:1 to about 1:1, about 10:1 to about 1:1000, about 10:1 to about 1:500, about 1:10, to about 1:200, about 10:1 to about 1:100, about 10:1 to about 1:50, about 10:1 to about 1:10, about 10:1 to about 1:1. In some embodiments, the weight ratio of emulsification additive to quantum dots is about 1000:1, about 500:1, about 200:1, about 100:1, about 50:1, about 10:1, about 1:1, about 1:10, about 1:50, about 1:100, about 1:200, about 1:500, or about 1:1000.

In some embodiments, the emulsification additive is present as a weight percent of the quantum dot composition (weight/weight) between about 0.01% to about 50%, about 0.01% to about 25%, about 0.01% to about 20%, about 0.01% to about 15%, about 0.01% to about 10%, about 0.01% to about 5%, about 0.01% to about 2%, about 0.01% to about 1%, about 1% to about 50%, about 1% to about 25%, about 1% to about 20%, about 1% to about 15%, about 1% to about 10%, about 1% to about 5%, about 1% to about 2%, about 2% to about 50%, about 2% to about 25%, about 2% to about 20%, about 2% to about 15%, about 2% to about 10%, about 2% to about 5%, 5% to about 50%, about 5% to about 25%, about 5% to about 20%, about 5% to about 15%, about 5% to about 10%, about 10% to about 50%, about 10% to about 25%, about 10% to about 20%, about 10% to about 15%, about 15% to about 50%, about 15% to about 25%, about 15% to about 20%, about 20% to about 50%, about 20% to about 25%, or about 25% to about 50%.

In some embodiments, the emulsification additive is present as a weight percent of the quantum dot molded article (weight/weight) between about 0.01% to about 50%, about 0.01% to about 25%, about 0.01% to about 20%, about 0.01% to about 15%, about 0.01% to about 10%, about 0.01% to about 5%, about 0.01% to about 2%, about 0.01% to about 1%, about 1% to about 50%, about 1% to about 25%, about 1% to about 20%, about 1% to about 15%, about 1% to about 10%, about 1% to about 5%, about 1% to about 2%, about 2% to about 50%, about 2% to about 25%, about 2% to about 20%, about 2% to about 15%, about 2% to about 10%, about 2% to about 5%, 5% to about 50%, about 5% to about 25%, about 5% to about 20%, about 5% to about 15%, about 5% to about 10%, about 10% to about 50%, about 10% to about 25%, about 10% to about 20%, about 10% to about 15%, about 15% to about 50%, about 15% to about 25%, about 15% to about 20%, about 20% to about 50%, about 20% to about 25%, or about 25% to about 50%.

### Solvents

In some embodiments, the quantum dot composition further comprises a solvent. In some embodiments, the solvent is selected from the group consisting of formic acid, acetic acid, chloroform, acetone, butanone, fatty alcohol and ethylene glycol monomethyl ether, ethylene glycol monoethyl ether, ethylene glycol monopropyl ether, ethylene glycol monobutyl ether, diethylene glycol diethyl ether acetic acetate, methyl ethyl ketone, methyl isobutyl ketone, monomethyl ether glycol ester, gamma-butyrolactone, methylacetic-3-ethyl ether, butyl carbitol, butyl carbitol acetate, propanediol monomethyl ether, propanediol monomethyl ether acetate, cyclohexane toluene, xylene, isopropyl alcohol, and combinations thereof.

### Organic Resin

In some embodiments, the organic resin is a thermosetting resin or a ultraviolet (UV) curable resin. In some embodiments, the organic resin is cured with a method that facilitates roll-to-roll processing.

Thermosetting resins require curing in which they undergo an irreversible molecular cross-linking process which renders the resin infusible. In some embodiments, the thermosetting resin is an epoxy resin, a phenolic resin, a vinyl resin, a melamine resin, a urea resin, an unsaturated polyester resin, a polyurethane resin, an allyl resin, an acrylic resin, a polyamide resin, a polyamide-imide resin, a phenolamine condensation polymerization resin, a urea melamine condensation polymerization resin, or combinations thereof.

In some embodiments, the thermosetting resin is an epoxy resin. Epoxy resins are easily cured without evolution of volatiles or by-products by a wide range of chemicals. Epoxy resins are also compatible with most substrates and tend to wet surfaces easily. See Boyle, M. A., et al., “Epoxy Resins,” Composites, Vol. 21, ASM Handbook, pages 78-89 (2001).

In some embodiments, the organic resin is a silicone thermosetting resin. In some embodiments, the silicone thermosetting resin is OE6630A or OE6630B (Dow Corning Corporation, Auburn, Mich.).

In some embodiments, a thermal initiator is used. In some embodiments, the thermal initiator is AIBN [2,2′-Azobis(2-methylpropionitrile)] or benzoyl peroxide.

UV curable resins are polymers that cure and quickly harden when exposed to a specific light wavelength. In some embodiments, the UV curable resin is a resin having as a functional group a radical-polymerization group such as a (meth)acryloyloxy group, a vinyloxy group, a styryl group, or a vinyl group; a cation-polymerizable group such as an epoxy group, a thioepoxy group, a vinyloxy group, or an oxetanyl group. In some embodiments, the UV curable resin is a polyester resin, a polyether resin, a (meth)acrylic resin, an epoxy resin, a urethane resin, an alkyd resin, a spiroacetal resin, a polybutadiene resin, or a thiolene resin.

In some embodiments, the UV curable resin is selected from the group consisting of urethane acrylate, allyloxylated cyclohexyl diacrylate, bis(acryloxy ethyl)hydroxyl isocyanurate, bis(acryloxy neopentylglycol)adipate, bisphenol A diacrylate, bisphenol A dimethacrylate, 1,4-butanediol diacrylate, 1,4-butanediol dimethacrylate, 1,3-butyleneglycol diacrylate, 1,3-butyleneglycol dimethacrylate, dicyclopentanyl diacrylate, diethyleneglycol diacrylate, diethyleneglycol dimethacrylate, dipentaerythritol hexaacrylate, dipentaerythritol monohydroxy pentaacrylate, di(trimethylolpropane) tetraacrylate, ethyleneglycol dimethacrylate, glycerol methacrylate, 1,6-hexanediol diacrylate, neopentylglycol dimethacrylate, neopentylglycol hydroxypivalate diacrylate, pentaerythritol triacrylate, pentaerythritol tetraacrylate, phosphoric acid dimethacrylate, polyethyleneglycol diacrylate, polypropyleneglycol diacrylate, tetraethyleneglycol diacrylate, tetrabromobisphenol A diacrylate, triethyleneglycol divinylether, triglycerol diacrylate, trimethylolpropane triacrylate, tripropyleneglycol diacrylate, tris(acryloxyethyl)isocyanurate, phosphoric acid triacrylate, phosphoric acid diacrylate, acrylic acid propargyl ester, vinyl terminated polydimethylsiloxane, vinyl terminated diphenylsiloxane-dimethylsiloxane copolymer, vinyl terminated polyphenylmethylsiloxane, vinyl terminated trifluoromethylsiloxane-dimethylsiloxane copolymer, vinyl terminated diethylsiloxane-dimethylsiloxane copolymer, vinylmethylsiloxane, monomethacryloyloxypropyl terminated polydimethyl siloxane, monovinyl terminated polydimethyl siloxane, monoallyl-mono trimethylsiloxy terminated polyethylene oxide, and combinations thereof.

In some embodiments, the UV curable resin is a mercapto-functional compound that can be cross-linked with an isocyanate, an epoxy, or an unsaturated compound under UV curing conditions. In some embodiments, the mercapto-functional compound is a polythiol. In some embodiments, the polythiol is pentaerythritol tetra(3-mercapto-propionate) (PETMP); trimethylol-propane tri(3-mercapto-propionate) (TMPMP); glycol di(3-mercapto-propionate) (GDMP); tris[25-(3-mercapto-propionyloxy)ethyl]isocyanurate (TEMPIC); dipentaerythritol hexa(3-mercapto-propionate) (Di-PETMP); ethoxylated trimethylolpropane tri(3-mercapto-propionate) (ETTMP 1300 and ETTMP 700); polycaprolactone tetra(3-mercapto-propionate) (PCL4MP 1350); pentaerythritol tetramercaptoacetate (PETMA); trimethylol-propane trimercaptoacetate (TMPMA); or glycol dimercaptoacetate (GDMA). These compounds are sold under the trade name THIOCURE® by Bruno Bock, Marschacht, Germany.

In some embodiments, the UV curable resin further comprises a photoinitiator. A photoinitiator initiates the crosslinking and/or curing reaction of the photosensitive material during exposure to light. In some embodiments, the photoinitiator is acetophenone-based, benzoin-based, or thioxanthenone-based.

In some embodiments, the UV curable resin comprises a mercapto-functional compound and a methacrylate, an acrylate, an isocyanate, or combinations thereof. In some embodiments, the UV curable resin comprises a polythiol and a methacrylate, an acrylate, an isocyanate, or combinations thereof.

In some embodiments, the photoinitiator is MINS-311RM (Minuta Technology Co., Ltd, Korea).

In some embodiments, the photoinitiator is IRGACURE® 127, IRGACURE® 184, IRGACURE® 184D, IRGACURE® 2022, IRGACURE® 2100, IRGACURE® 250, IRGACURE® 270, IRGACURE® 2959, IRGACURE® 369, IRGACURE® 369 EG, IRGACURE® 379, IRGACURE® 500, IRGACURE® 651, IRGACURE® 754, IRGACURE® 784, IRGACURE® 819, IRGACURE® 819Dw, IRGACURE® 907, IRGACURE® 907 FF, IRGACURE® Oxe01, IRGACURE® TPO-L, IRGACURE® 1173, IRGACURE® 1173D, IRGACURE® 4265, IRGACURE® BP, or IRGACURE® MBF (BASF Corporation, Wyandotte, Mich.). In some embodiments, the photoinitiator is TPO (2,4,6-trimethylbenzoyl-diphenyl-phosphine oxide) or MBF (methyl benzoylformate).

In some embodiments, the organic resin comprises, as a weight percent of the quantum dot composition (weight/weight), between about 50% and about 99%, about 50% and about 95%, about 50% and about 90%, about 50% and about 85%, about 50% and about 80%, about 50% and about 70%, about 50% and about 60%, about 60% and about 99%, about 60% and about 95%, about 60% and about 90%, about 60% and about 85%, about 60% and about 80%, about 60% and about 70%, about 70% and about 99%, about 70% and about 95%, about 70% and about 90%, about 70% and about 85%, about 70% and about 80%, about 80% and about 99%, about 80% and about 95%, about 80% and about 90%, about 80% and about 85%, about 85% and about 99%, about 85% and about 95%, about 85% and about 90%, about 90% and about 99%, about 90% and about 95%, or about 95% and about 99%.

In some embodiments, the organic resin comprises as a weight percent of the quantum dot molded article (weight/weight) between about 50% and about 99%, about 50% and about 95%, about 50% and about 90%, about 50% and about 85%, about 50% and about 80%, about 50% and about 70%, about 50% and about 60%, about 60% and about 99%, about 60% and about 95%, about 60% and about 90%, about 60% and about 85%, about 60% and about 80%, about 60% and about 70%, about 70% and about 99%, about 70% and about 95%, about 70% and about 90%, about 70% and about 85%, about 70% and about 80%, about 80% and about 99%, about 80% and about 95%, about 80% and about 90%, about 80% and about 85%, about 85% and about 99%, about 85% and about 95%, about 85% and about 90%, about 90% and about 99%, about 90% and about 95%, or about 95% and about 99%.

### Making the Quantum Dot Compositions

The present invention provides a method of making a quantum dot composition comprising admixing at least one population of quantum dots and at least one siloxane polymer, optionally at least one emulsification additive, and optionally at least one organic resin.

The present invention provides a method of preparing a quantum dot composition, the method comprising:
(a) providing a composition comprising at least one population of quantum dots and at least one siloxane polymer;
(b) admixing at least one organic resin with the composition of (a); and
(c) admixing at least one emulsification additive with the composition of (b).

The present invention provides a method of preparing a quantum dot composition, the method comprising:
(a) providing a composition comprising at least one population of quantum dots and at least one siloxane polymer;
(b) admixing at least one emulsification additive with the composition of (a); and
(c) admixing at least one organic resin with the composition of (b).

The siloxane polymer provides increased stability to the population of quantum dots and allows for storage of the quantum dots for extended periods of time. In some embodiments, the population of quantum dots can be stored in an siloxane polymer for between 1 minute and 3 years, between 1 minute and 12 months, between 1 minute and 6 months, between 1 minute and 3 months, between 1 minute and 1 month, between 1 minute and 15 days, between 1 minute and 1 day, between 1 day and 3 years, between 1 day and 12 months, between 1 day and 6 months, between 1 day and 3 months, between 1 day and 1 month, between 1 day and 15 days, between 15 days and 3 years, between 15 days and 12 months, between 15 days and 6 months, between 15 days and 3 months, between 15 days and 1 month, between 1 month and 3 years, between 1 month and 12 months, between 1 month and 6 months, between 1 month and 3 months, between 3 months and 3 years, between 3 months and 12 months, between 3 months and 6 months, between 6 months and 3 years, between 6 months and 12 months, or between 12 months and 3 years.

In some embodiments, if more than one population of quantum dots is used, the at least two populations of quantum dots stored in at least one siloxane polymer are added together and are mixed. In some embodiments, the siloxane polymers are the same. In some embodiments, the siloxane polymers are different.

In some embodiments, a first population of quantum dots in an siloxane polymer is mixed with a second population of quantum dots in an siloxane polymer at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm.

In some embodiments, a first population of quantum dots in a siloxane polymer is mixed with a second population of quantum dots in a siloxane polymer for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, a first organic resin is mixed with a second organic resin. In some embodiments, a first organic resin is mixed with a second organic resin at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm. In some embodiments, the mixture further comprises at least one solvent.

In some embodiments, a first organic resin is mixed with a second organic resin for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, at least one emulsification additive is added to the at least one population of quantum dots and the at least one siloxane polymer. In some embodiments, the emulsification additive does not react with the at least one siloxane polymer and the mixture is stable for an extended period of time.

In some embodiments, the at least one population of quantum dots in at least one siloxane polymer is mixed with at least one emulsification additive at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm.

In some embodiments, the at least one population of quantum dots in at least one siloxane polymer is mixed with at least one emulsification additive for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, the composition comprising at least one population of quantum dots, at least siloxane polymer, and at least one emulsification additive is mixed with the at least one organic resin at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm. In some embodiments, the mixture further comprises at least one solvent.

In some embodiments, the composition comprising at least one population of quantum dots, at least one siloxane polymer, and at least one emulsification additive is mixed with the at least one organic resin for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, at least one population of quantum dots, at least one siloxane polymer, and at least one organic resin are mixed. In some embodiments, the organic resin does not react with the siloxane polymer and the mixture can be stored for extended lengths of time.

In some embodiments, the at least one population of quantum dots in at least one siloxane polymer is mixed with at least one organic resin at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm.

In some embodiments, the at least one population of quantum dots in at least one siloxane polymer is mixed with at least one organic resin for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, the composition comprising at least one population of quantum dots, at least one siloxane polymer, and at least one organic resin is mixed with an emulsification additive at an agitation rate of between 100 rpm and 10,000 rpm, between 100 rpm and 5,000 rpm, between 100 rpm and 3,000 rpm, between 100 rpm and 1,000 rpm, between 100 rpm and 500 rpm, between 500 rpm and 10,000 rpm, between 500 rpm and 5,000 rpm, between 500 rpm and 3,000 rpm, between 500 rpm and 1,000 rpm, between 1,000 rpm and 10,000 rpm, between 1,000 rpm and 5,000 rpm, between 1,000 rpm and 3,000 rpm, between 3,000 rpm and 10,000 rpm, between 3,000 rpm and 10,000 rpm, and between 5,000 rpm and 10,000 rpm. In some embodiments, the composition further comprises at least one solvent.

In some embodiments, the composition comprising at least one population of quantum dots, at least one siloxane polymer, and at least one organic resin is mixed with an emulsification additive for a time of between 10 minutes and 24 hours, between 10 minutes and 20 hours, between 10 minutes and 15 hours, between 10 minutes and 10 hours, between 10 minutes and 5 hours, between 10 minutes and 1 hour, between 10 minutes and 30 minutes, between 30 minutes and 24 hours, between 30 minutes and 20 hours, between 30 minutes and 15 hours, between 30 minutes and 10 hours, between 30 minutes and 5 hours, between 30 minutes and 1 hour, between 1 hour and 24 hours, between 1 hour and 20 hours, between 1 hour and 15 hours, between 1 hour and 10 hours, between 1 hour and 5 hours, between 5 hours and 24 hours, between 5 hours and 20 hours, between 5 hours and 15 hours, between 5 hours and 10 hours, between 10 hours and 24 hours, between 10 hours and 20 hours, between 10 hours and 15 hours, between 15 hours and 24 hours, between 15 hours and 20 hours, or between 20 hours and 24 hours.

In some embodiments, the composition comprising at least one population of quantum dots, at least one siloxane polymer, at least one emulsification additive, and at least one organic resin can be stored for between 1 minute and 3 years, between 1 minute and 12 months, between 1 minute and 6 months, between 1 minute and 3 months, between 1 minute and 1 month, between 1 minute and 15 days, between 1 minute and 1 day, between 1 day and 3 years, between 1 day and 12 months, between 1 day and 6 months, between 1 day and 3 months, between 1 day and 1 month, between 1 day and 15 days, between 15 days and 3 years, between 15 days and 12 months, between 15 days and 6 months, between 15 days and 3 months, between 15 days and 1 month, between 1 month and 3 years, between 1 month and 12 months, between 1 month and 6 months, between 1 month and 3 months, between 3 months and 3 years, between 3 months and 12 months, between 3 months and 6 months, between 6 months and 3 years, between 6 months and 12 months, or between 12 months and 3 years before further use.

In some embodiments, a thermal initiator or a photoinitiator can be added to the quantum dot composition to facilitate curing.

### Making a Quantum Dot Layer

The quantum dots used in the present invention can be embedded in a polymeric matrix using any suitable method. As used herein, the term “embedded” is used to indicate that the quantum dot population is enclosed or encased with the polymer that makes up the majority of the component of the matrix. The some embodiments, the at least one quantum dot population is suitably uniformly distributed throughout the matrix. In some embodiments, the at least one quantum dot population is distributed according to an application-specific distribution. In some embodiments, the quantum dots are mixed in a polymer and applied to the surface of a substrate.

The quantum dot composition can be deposited by any suitable method known in the art, including but not limited to painting, spray coating, solvent spraying, wet coating, adhesive coating, spin coating, tape-coating, roll coating, flow coating, inkjet vapor jetting, drop casting, blade coating, mist deposition, or a combination thereof. Preferably, the quantum dot composition is cured after deposition. Suitable curing methods include photo-curing, such as UV curing, and thermal curing. Traditional laminate film processing methods, tape-coating methods, and/or roll-to-roll fabrication methods can be employed in forming the quantum dot films of the present invention. The quantum dot composition can be coated directly onto the desired layer of a substrate. Alternatively, the quantum dot composition can be formed into a solid layer as an independent element and subsequently applied to the substrate. In some embodiments, the quantum dot composition can be deposited on one or more barrier layers.

### Spin Coating

In some embodiments, the quantum dot composition is deposited onto a substrate using spin coating. In spin coating a small amount of material is typically deposited onto the center of a substrate loaded a machine called the spinner which is secured by a vacuum. A high speed of rotation is applied on the substrate through the spinner which causes centripetal force to spread the material from the center to the edge of the substrate. While most of the material would be spun off, a certain amount remains of the substrate, forming a thin film of material on the surface as the rotation continues. The final thickness of the film is determined by the nature of the deposited material and the substrate in addition to the parameters chosen for the spin process such as spin speed, acceleration, and spin time. For typical films, a spin speed of 1500 to 6000 rpm is used with a spin time of 10-60 seconds.

### Mist Deposition

In some embodiments, the quantum dot composition is deposited onto a substrate using mist deposition. Mist deposition takes place at room temperature and atmospheric pressure and allows precise control over film thickness by changing the process conditions. During mist deposition, a liquid source material is turned into a very fine mist and carried to the deposition chamber by nitrogen gas. The mist is then drawn to a surface by a high voltage potential between the field screen and the holder. Once the droplets coalesce on the surface, the surface is removed from the chamber and thermally cured to allow the solvent to evaporate. The liquid precursor is a mixture of solvent and material to be deposited. It is carried to the atomizer by pressurized nitrogen gas. Price, S. C., et al., “Formation of Ultra-Thin Quantum Dot Films by Mist Deposition,” ESC Transactions 11:89-94 (2007).

### Spray Coating

In some embodiments, the quantum dot composition is deposited onto a substrate using spray coating. The typical equipment for spray coating comprises a spray nozzle, an atomizer, a precursor solution, and a carrier gas. In the spray deposition process, a precursor solution is pulverized into micro sized drops by means of a carrier gas or by atomization (e.g., ultrasonic, air blast, or electrostatic). The droplets that come out of the atomizer are accelerated by the substrate surface through the nozzle by help of the carrier gas which is controlled and regulated as desired. Relative motion between the spray nozzle and the substrate is defined by design for the purpose of full coverage on the substrate.

In some embodiments, application of the quantum dot composition further comprises a solvent. In some embodiments, the solvent for application of the quantum dot composition is water, organic solvents, inorganic solvents, halogenated organic solvents, or mixtures thereof. Illustrative solvents include, but are not limited to, water, D₂O, acetone, ethanol, dioxane, ethyl acetate, methyl ethyl ketone, isopropanol, anisole, γ-butyrolactone, dimethylformamide, N-methylpyrrolidinone, dimethylacetamide, hexamethylphosphoramide, toluene, dimethylsulfoxide, cyclopentanone, tetramethylene sulfoxide, xylene, ε-caprolactone, tetrahydrofuran, tetrachloroethylene, chloroform, chlorobenzene, dichloromethane, 1,2-dichloroethane, 1,1,2,2-tetrachloroethane, or mixtures thereof.

In some embodiments, the compositions are thermally cured to form the quantum dot layer. In some embodiments, the compositions are cured using UV light. In some embodiments, the quantum dot composition is coated directly onto a barrier layer of a quantum dot film, and an additional barrier layer is subsequently deposited upon the quantum dot layer to create the quantum dot film. A support substrate can be employed beneath the barrier film for added strength, stability, and coating uniformity, and to prevent material inconsistency, air bubble formation, and wrinkling or folding of the barrier layer material or other materials. Additionally, one or more barrier layers are preferably deposited over a quantum dot layer to seal the material between the top and bottom barrier layers. Suitably, the barrier layers can be deposited as a laminate film and optionally sealed or further processed, followed by incorporation of the quantum dot film into the particular lighting device. The quantum dot composition deposition process can include additional or varied components, as will be understood by persons of ordinary skill in the art. Such embodiments will allow for in-line process adjustments of the quantum dot emission characteristics, such as brightness and color (e.g., to adjust the quantum film white point), as well as the quantum dot film thickness and other characteristics. Additionally, these embodiments will allow for periodic testing of the quantum dot film characteristics during production, as well as any necessary toggling to achieve precise quantum dot film characteristics. Such testing and adjustments can also be accomplished without changing the mechanical configuration of the processing line, as a computer program can be employed to electronically change the respective amounts of mixtures to be used in forming a quantum dot film.

### Barrier Layers

In some embodiments, the quantum dot molded article comprises one or more barrier layers disposed on either one or both sides of the quantum dot layer. Suitable barrier layers protect the quantum dot layer and the quantum dot molded article from environmental conditions such as high temperatures, oxygen, and moisture. Suitable barrier materials include non-yellowing, transparent optical materials which are hydrophobic, chemically and mechanically compatible with the quantum dot molded article, exhibit photo- and chemical-stability, and can withstand high temperatures. In some embodiments, the one or more barrier layers have a similar refractive index to the quantum dot molded article. In some embodiments, the matrix material of the quantum dot molded article and the one or more adjacent barrier layers have similar refractive indices, such that most of the light transmitting through the barrier layer toward the quantum dot molded article is transmitted from the barrier layer into the quantum dot layer. Using materials with similar refractive indexes reduces optical losses at the interface between the barrier and matrix materials.

The barrier layers are suitably solid materials, and can be a cured liquid, gel, or polymer. The barrier layers can comprise flexible or non-flexible materials, depending on the particular application. Barrier layers are preferably planar layers, and can include any suitable shape and surface area configuration, depending on the particular lighting application. In preferred embodiments, the one or more barrier layers will be compatible with laminate film processing techniques, whereby the quantum dot layer is disposed on at least a first barrier layer, and at least a second barrier layer is disposed on the quantum dot layer on a side opposite the quantum dot layer to form the quantum dot molded article according to one embodiment of the present invention. Suitable barrier materials include any suitable barrier materials known in the art. For example, suitable barrier materials include glasses, polymers, and oxides. Suitable barrier layer materials include, but are not limited to, polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof. Preferably, each barrier layer of the quantum dot molded article comprises at least 2 layers comprising different materials or compositions, such that the multi-layered barrier eliminates or reduces pinhole defect alignment in the barrier layer, providing an effective barrier to oxygen and moisture penetration into the quantum dot layer. The quantum dot layer can include any suitable material or combination of materials and any suitable number of barrier layers on either or both sides of the quantum dot layer. The materials, thickness, and number of barrier layers will depend on the particular application, and will suitably be chosen to maximize barrier protection and brightness of the quantum dot layer while minimizing thickness of the quantum dot molded article. In preferred embodiments, each barrier layer comprises a laminate film, preferably a dual laminate film, wherein the thickness of each barrier layer is sufficiently thick to eliminate wrinkling in roll-to-roll or laminate manufacturing processes. The number or thickness of the barriers may further depend on legal toxicity guidelines in embodiments where the quantum dots comprise heavy metals or other toxic materials, which guidelines may require more or thicker barrier layers. Additional considerations for the barriers include cost, availability, and mechanical strength.

In some embodiments, the quantum dot film comprises two or more barrier layers adjacent each side of the quantum dot layer, for example, two or three layers on each side or two barrier layers on each side of the quantum dot layer. In some embodiments, each barrier layer comprises a thin glass sheet, e.g., glass sheets having a thickness of about 100 μm, 100 μm or less, 50 μm or less, preferably 50 μm or about 50 μm.

Each barrier layer of the quantum dot film of the present invention can have any suitable thickness, which will depend on the particular requirements and characteristics of the lighting device and application, as well as the individual film components such as the barrier layers and the quantum dot layer, as will be understood by persons of ordinary skill in the art. In some embodiments, each barrier layer can have a thickness of 50 μm or less, 40 μm or less, 30 μm or less, 25 μm or less, 20 μm or less, or 15 μm or less. In certain embodiments, the barrier layer comprises an oxide coating, which can comprise materials such as silicon oxide, titanium oxide, and aluminum oxide (e.g., SiO₂, Si₂O₃, TiO₂, or Al₂O₃). The oxide coating can have a thickness of about 10 μm or less, 5 μm or less, 1 μm or less, or 100 nm or less. In certain embodiments, the barrier comprises a thin oxide coating with a thickness of about 100 nm or less, 10 nm or less, 5 nm or less, or 3 nm or less. The top and/or bottom barrier can consist of the thin oxide coating, or may comprise the thin oxide coating and one or more additional material layers.

### Quantum Dot Film Features and Embodiments

In certain embodiments, the quantum dot films of the present invention are used to form display devices. As used herein, a display device refers to any system with a lighting display. Such devices include, but are not limited to, devices encompassing a liquid crystal display (LCD), televisions, computers, mobile phones, smart phones, personal digital assistants (PDAs), gaming devices, electronic reading devices, digital cameras, and the like.

In some embodiments, the optical films containing nanostructure compositions are substantially free of cadmium. As used herein, the term “substantially free of cadmium” is intended that the nanostructure compositions contain less than 100 ppm by weight of cadmium. The RoHS compliance definition requires that there must be no more than 0.01% (100 ppm) by weight of cadmium in the raw homogeneous precursor materials. The cadmium concentration can be measured by inductively coupled plasma mass spectroscopy (ICP-MS) analysis, and are on the parts per billion (ppb) level. In some embodiments, optical films that are “substantially free of cadmium” contain 10 to 90 ppm cadmium. In other embodiment, optical films that are substantially free of cadmium contain less than about 50 ppm, less than about 20 ppm, less than about 10 ppm, or less than about 1 ppm of cadmium.

### EXAMPLES

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

### Example 1

Photocurable Quantum Dot-Resin Formulation without Emulsification Additive

Pentaerythritol tetrakis (3-mercaptopriopionate) (6.67 g) (Evans Chemetics LP, Teaneck, N.J.), Trimethylolpropane tris(3-mercaptopriopionate) (26.67 g) (Evans Chemetics LP, Teaneck, N.J.), Triallyl triazine trione (26.67 g) (Sartomer USA, Exton, Pa.), and IRGACURE® TPO-L (0.6 g) (BASF Corporation, Wyandotte, Mich.) are mixed for 2 minutes in a planetary vacuum mixer at 2000 rpm.

Afterwards, aminosilicone-based Green Quantum Dot Concentrate (Nanosys, Milpitas, Calif.) (3.24 g) and aminosilicone-based Red Quantum Dot Concentrate (Nanosys, Milpitas, Calif.) (0.85 g) are added and the mixture is again mixed for 2 minutes in a planetary vacuum mixer at 2000 rpm.

### Example 2

Photocurable Quantum Dot-Resin Formulation with Emulsification Additive 1

To a portion of the mixture from Example 1 (6.0 g) is added the silicone copolymer emulsification additive BYK-UV 3510 (0.09 g) (BYK Additives and Instruments, Germany). The mixture is again mixed for 2 minutes in a planetary vacuum mixer at 2000 rpm.

### Example 3

Photocurable Quantum Dot-Resin Formulation with Emulsification Additive 2

To a portion of the mixture from Example 1 (6.0 g) is added the silicone copolymer emulsification additive GP-675 (0.09 g) (Genesee Polymers, Flint, Mich.) The mixture is again mixed for 2 minutes in a planetary vacuum mixer at 2000 rpm.

### Example 4

### Preparation of a Cured Quantum-Dot-Containing Film

The photocurable quantum dot-contain resin from Example 1, 2, or 3 is coated between two pieces of barrier film, with the thickness of the coating controlled to 100 um. The coating is then exposed to 1.6 J/cm² of UVA ultraviolet light. The film is now cured.

### Example 5

### Measurement of Optical Properties

The white point (x, y) and luminance (L) of the films are measured on a light-recycling backlight unit, similar to a typical backlit display. The unit uses blue LED's for the backlight. The blue backlight excites the quantum dots in the film, which is sandwiched between the backlight and a pair of brightness enhancing films (BEF's). The BEF's partially reflect light back into the unit, which then recycles between the BEF's and a back reflector, exciting more quantum dots as the light recycles. The output spectrum is measured from the front of the unit with a calibrated spectrometer and the color and luminance is calculated using CIE 1931 coefficients.

### Example 6

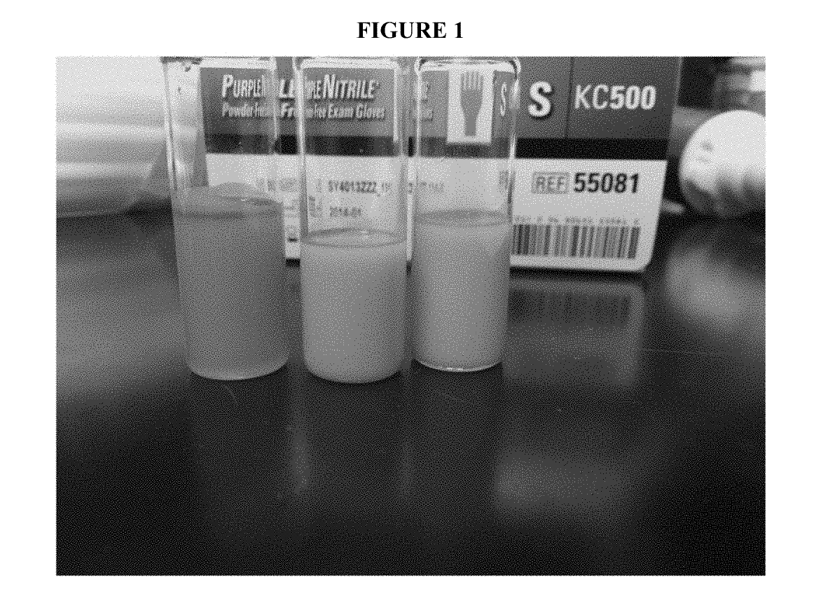

Three mixtures comprising quantum dots, a silicone polymer, and a low viscosity thiolene UV curable resin were mixed in the same concentration in a planetary vacuum mixer. Two of the resin materials also contained a emulsification additive: BYK-UV 3510 (BYK Additives and Instruments, Germany) or GP-675 (Genesee Polymer Corporation, Burton, Mich.). It was observed that the mixtures containing the emulsification additive appeared to have a much greater scatter than the mixture without an emulsification additive. After storage for 48 hours, the mixtures containing the emulsification additives also had much less separation of the quantum dot from the bulk of the mixture (FIG. 1). Microscopic analysis of these mixtures demonstrated that the quantum dot concentrate in the samples with the emulsification additives were in much smaller domains than the sample without the emulsification additive.

Films were cast from each of the three mixtures. For the samples that contained the emulsification additives, the white points of the films (as expressed by x and y) were warmer, resulting in a film with a higher brightness (L) as shown in TABLE 1.

TABLE 1

| Emulsification Additive | x | y | L (nits) |
|---|---|---|---|
| None | 0.2347 | 0.2124 | 1463 |
| BYK-UV 3510 | 0.2461 | 0.2364 | 1540 |
| GP-675 | 0.2492 | 0.2396 | 1534 |

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

1. A quantum dot composition, comprising:
(a) at least one population of quantum dots;
(b) at least one siloxane polymer;
(c) at least one emulsification additive; and
(d) at least one organic resin.

2. The quantum dot composition of claim 1, comprising between one and five populations of quantum dots.

3. (canceled)

4. The quantum dot composition of claim 1, wherein the at least one population of quantum dots contains a core selected from the group consisting of InP, InZnP, InGaP, CdSe, CdS, CdSSe, CdZnSe, CdZnS, ZnSe, ZnSSe, InAs, InGaAs, and InAsP.

5. (canceled)

6. The quantum dot composition of claim 1, comprising between one and five siloxane polymers.

7.-8. (canceled)

9. The quantum dot composition of claim 1, comprising between one and five emulsification additives.

10. (canceled)

11. The quantum dot composition of claim 1, wherein the at least one emulsification additive is a polymer with an ethylene oxide backbone, an ethylene oxide side chain, or combinations thereof.

12. The quantum dot composition of claim 1, wherein the at least one emulsification additive has the structure of formula II: 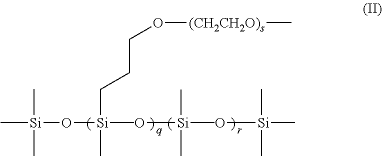
wherein q and r are integers between 1 and 50 and s is an integer between 1 and 20.

13. (canceled)

14. The quantum dot composition of claim 1, comprising between one and five organic resins.

15.-16. (canceled)

17. The quantum dot composition of claim 1, wherein the at least one organic resin is a UV curable resin.

18. The quantum dot composition of claim 1, wherein the at least one organic resin is a mercapto-functional compound.

19. The quantum dot composition of claim 1, further comprising a thermal initiator or a photoinitiator.

20. (canceled)

21. The quantum dot composition of claim 1, wherein the composition is stable for between 1 minute and 3 years.

22. The quantum dot composition of claim 1, wherein the quantum dot composition comprises two populations of quantum dots, two siloxane polymers, one emulsification additive, and two organic resins.

23.-25. (canceled)

26. A method of preparing a quantum dot composition, the method comprising:
(1) (a) providing a composition comprising at least one population of quantum dots and at least one siloxane polymer;
(b) admixing at least one emulsification additive with the composition of (a); and
(c) admixing at least one organic resin with the composition of (b); or
(2) (a) providing a composition comprising at least one population of quantum dots and at least one siloxane polymer;
(b) admixing at least one organic resin with the composition of (a); and
(c) admixing at least one emulsification additive with the composition of (b).

27. (canceled)

28. The method of claim 26, wherein the at least one population of quantum dots contains a core selected from the group consisting of InP, InZnP, InGaP, CdSe, CdS, CdSSe, CdZnSe, CdZnS, ZnSe, ZnSSe, InAs, InGaAs, and InAsP.

29. (canceled)

30. The method of claim 26, comprising between one and five siloxane polymers.

31.-32. (canceled)

33. The method of claim 26, comprising between one and five emulsification additives.

34. (canceled)

35. The method of claim 26, wherein the at least one emulsification additive is a polymer with an ethylene oxide backbone, an ethylene oxide side chain, or combinations thereof.

36. The method of claim 26, wherein the at least one emulsification additive has the structure of formula II: 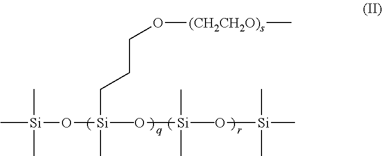
wherein q and r are integers between 1 and 50 and s is an integer between 1 and 20.

37. (canceled)

38. The method of claim 26, wherein the composition of (a) was stored for between 1 minute and 3 years.

39.-42. (canceled)

43. The method of claim 26, wherein the at least one organic resin is a UV curable resin.

44. The method of claim 26, wherein the at least one organic resin is a mercapto-functional compound.

45. The method of claim 26, further comprising:
(d) admixing at least one thermal initiator or photoinitiator with the composition of (c).

46.-48. (canceled)

49. The method of claim 26, wherein the composition is stable for between 1 minute and 3 years.

50.-73. (canceled)
